(19) United States
(12) Patent Application Publication
(10) Pub. No.: US 2024/0340146 A1
(43) Pub. Date: Oct. 10, 2024

(54) METHOD AND DEVICE FOR RECEIVING AND TRANSMITTING CSI REPORT IN WIRELESS COMMUNICATION SYSTEM

(71) Applicant: Samsung Electronics Co., Ltd., Suwon-si (KR)

(72) Inventors: Zhe CHEN, Beijing (CN); Sa ZHANG, Beijing (CN); Feifei SUN, Beijing (CN)

(21) Appl. No.: 18/626,778

(22) Filed: Apr. 4, 2024

(30) Foreign Application Priority Data
Apr. 4, 2023 (CN) 202310355955.8

(51) Int. Cl. H04L 5/00; H04B 7/0456

(52) U.S. Cl. CPC H04L 5/0053; H04B 7/0456

(57) ABSTRACT

In accordance with an aspect of the disclosure, a method performed by a user equipment (UE) in a wireless communication system is provided, the method comprises receiving, from a base station, configuration information for a channel state information (CSI) report, the configuration information including a list of sub-configurations for the CSI report, identifying, based on the list of sub-configurations, a mapping order for at least one of precoding matrix indicator (PMI) related to parameters or channel quality indicator (CQI) related parameters, and transmitting, to the base station, the CSI report corresponding to one or more sub-configurations among the list of sub-configurations, based on the mapping order.

### CROSS-REFERENCE TO RELATED APPLICATION(S)

This application is based on and claims priority under 35 U.S.C. § 119 (a) of a Chinese patent application number 202310355955.8, filed on Apr. 4, 2023, in the Chinese Intellectual Property Office, the disclosure of which is incorporated by reference herein in its entirety.

### BACKGROUND

### 1. Field

The disclosure relates to the technical field of wireless communication. More particularly the disclosure relates to a method and device for receiving and transmitting information.

### 2. Description of Related Art

In order to meet the increasing demand for wireless data communication services since the deployment of fourth generation (4G) communication systems, efforts have been made to develop improved fifth generation (5G) or pre-5G communication systems. Therefore, 5G or pre-5G communication systems are also called “Beyond 4G networks” or “Post-long term evolution (LTE) systems”.

In order to achieve a higher data rate, 5G communication systems are implemented in higher frequency (millimeter wave, (mmWave)) bands, e.g., 60 gigahertz (GHz) bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

Transmission from a base station to a user equipment (UE) is called a downlink, and transmission from the UE to the base station is called an uplink.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for receiving and transmitting information.

Additional aspects will be set forth in part in the description which follows and, in part, will be apparent from the description, or may be learned by practice of the presented embodiments.

The present disclosure provides a method and apparatus for transmitting and receiving a CSI report efficiently in a wireless communication system.

In accordance with an aspect of the disclosure, a method performed by a user equipment (UE) in a wireless communication system is provided, the method comprises receiving, from a base station, configuration information for a channel state information (CSI) report, the configuration information including a list of sub-configurations for the CSI report, identifying, based on the list of sub-configurations, a mapping order for at least one of precoding matrix indicator (PMI) related to parameters or channel quality indicator (CQI) related parameters, and transmitting, to the base station, the CSI report corresponding to one or more sub-configurations among the list of sub-configurations, based on the mapping order.

In accordance with another aspect of the disclosure, a UE in a wireless communication system is provided, the UE comprises a transceiver, and a processor configured to receive, through the transceiver from a base station, configuration information for a CSI report, the configuration information including a list of sub-configurations for the CSI report, identify, based on the list of sub-configurations, a mapping order for at least one of PMI related to parameters or CQI related parameters, and transmit, to the base station through the transceiver, the CSI report corresponding to one or more sub-configurations among the list of sub-configurations, based on the mapping order.

In accordance with another aspect of the disclosure, a method performed by a base station in a wireless communication system is provided, the method comprises transmitting, to a UE, configuration information for a CSI report, the configuration information including a list of sub-configurations for the CSI report, identifying, based on the list of sub-configurations, a mapping order for at least one of PMI related to parameters or CQI related parameters, and receiving, from the UE, the CSI report corresponding to one or more sub-configurations among the list of sub-configurations, based on the mapping order.

In accordance with another aspect of the disclosure, a base station in a wireless communication system is provided, the base station comprises a transceiver, and a processor configured to transmit, to a UE through the transceiver, configuration information for a CSI report, the configuration information including a list of sub-configurations for the CSI report, identify, based on the list of sub-configurations, a mapping order for at least one of PMI related to parameters or CQI related parameters, and receive, through the transceiver from the UE, the CSI report corresponding to one or more sub-configurations among the list of sub-configurations, based on the mapping order.

In accordance with an aspect of the disclosure, a method performed by a user equipment (UE) in a wireless communication system is provided. The method includes receiving information for configuring channel state information (CSI) report, and determining CSI parameters based on a plurality of first parameter combinations included in the information for configuring CSI report, wherein the first parameter combinations include spatial parameters and/or power parameters, the CSI parameters are in a CSI report, and wherein if the plurality of first parameter combinations include a plurality of spatial parameters, the plurality of spatial parameters satisfy at least one of the following conditions first-dimension parameters (N1) corresponding to the plurality of spatial parameters respectively are related, second-dimension parameters (N2) corresponding to the plurality of spatial parameters respectively are related, products of the first-dimension parameters (N1) corresponding to the plurality of spatial parameters respectively and oversampling parameters (O1) corresponding to the plurality of spatial parameters respectively are related, products of the second-dimension parameters (N2) corresponding to the plurality of spatial parameters respectively and oversampling parameters (O2) corresponding to the plurality of spatial parameters respectively are related, the plurality of spatial parameters are associated with a same codebook type, the plurality of spatial parameters are associated with a same codebook mode, the plurality of spatial parameters are associated with a same frequency domain related parameter, the plurality of spatial parameters are associated with a same codebook restriction, and the plurality of spatial parameters are associated with a same rank indicator (RI) restriction.

In one example, first-dimension parameters (N1) corresponding to the plurality of spatial parameters respectively being related includes that the first-dimension parameters (N1) corresponding to the plurality of spatial parameters respectively are equal or have a multiple relationship with each other, second-dimension parameters (N1) corresponding to the plurality of spatial parameters respectively being related includes that the second-dimension parameters (N1) corresponding to the plurality of spatial parameters respectively are equal or have a multiple relationship with each other, products of the first-dimension parameters (N1) corresponding to the plurality of spatial parameters respectively and oversampling parameters (O1) corresponding to the plurality of spatial parameters respectively being related includes that the products of the first-dimension parameters (N1) corresponding to the plurality of spatial parameters respectively and oversampling parameters (O1) corresponding to the plurality of spatial parameters respectively are equal or have a multiple relationship with each other, and products of the second-dimension parameters (N2) corresponding to the plurality of spatial parameters respectively and oversampling parameters (O2) corresponding to the plurality of spatial parameters respectively being related includes that the products of the second-dimension parameters (N2) corresponding to the plurality of spatial parameters respectively and oversampling parameters (O2) corresponding to the plurality of spatial parameters respectively are equal or have a multiple relationship with each other.

In one example, each of the plurality of first parameter combinations is associated with one or more reference signal resources based on higher-layer signaling, and the CSI parameters are determined based on the plurality of first parameter combinations and the one or more reference signal resources.

In one example, a number of the CSI parameters is related to at least one of the following: a number of the one or more reference signal resources, and a number of combinations of the spatial parameters and/or the power parameters.

In one example, determining CSI parameters base on a plurality of first parameter combinations included in the information for configuring CSI report includes determining the CSI parameters based on a second parameter combination in the plurality of first parameter combinations.

In one example, the second parameter combination is predefined or indicated by a base station or reported by the UE.

In one example, a plurality of third parameter combinations in the plurality of first parameter combinations are associated with a first CSI parameter.

In one example, the third parameter combinations are predefined or indicated by the base station or reported by the UE.

In one example, the third parameter combinations being reported by the UE includes the CSI parameters include a first indicator for representing the plurality of third parameter combinations.

In one example, the first CSI parameter is determined based on all, part or one of the third parameter combinations.

In one example, the first CSI parameter is determined based on at least one of the following: indication information from the base station, a spatial parameter with the smallest value for associated first-dimension parameters (N1) and/or the corresponding oversampling parameters (O1) in the spatial parameters, a spatial parameter with the smallest value for associated second-dimension parameters (N2) and/or the corresponding oversampling parameters (O2) in the spatial parameters, a power parameter with the largest value or the smallest value in the power parameters, and positions of the plurality of third parameter combinations in the higher-layer signaling.

In one example, the first CSI parameter includes at least one of a precoding matrix indicator (PMI) parameter set, an RI parameter set, a layer indicator (LI) parameter set and/or a channel quality indicator (CQI) parameter set.

In one example, the plurality of third parameter combinations are subsets of the second parameter combination.

In one example, the plurality of third parameter combinations being associated with the PMI parameter set includes that the plurality of third parameter combinations are associated with subsets of the PMI parameter set.

In one example, the subsets of the PMI set are predefined or indicated by the base station or reported by the UE.

In one example, the subsets of the PMI set being reported by the UE includes that the CSI parameters include a second indicator for representing the subsets of the PMI parameter set.

In one example, the CSI report includes a first part and a second part, the first part includes at least one of a first indicator, a second indicator, an RI, a CSI-RS resource indicator (CRI), a CQI of a first codeword, and a zero-valued bit used to pad the first part to a fixed length, the second part includes at least one of a CQI, an LI and a PMI of a second codeword, and a load size of the second part is determined based on the first part.

In accordance with another aspect of the disclosure, a method performed by a base station in a wireless communication system is provided. The method includes transmitting information for configuring CSI report, and receiving CSI parameters in a CSI report, wherein the CSI parameters are determined based on a plurality of first parameter combinations included in the information for configuring CSI report, the first parameter combinations include spatial parameters and/or power parameters, and if the plurality of first parameter combinations include a plurality of spatial parameters, the plurality of spatial parameters satisfy at least one of the following conditions first-dimension parameters (N1) corresponding to the plurality of spatial parameters respectively are related, second-dimension parameters (N2) corresponding to the plurality of spatial parameters respectively are related, products of the first-dimension parameters (N1) and oversampling parameters (O1) corresponding to the plurality of spatial parameters respectively are related, products of the second-dimension parameters (N2) and oversampling parameters (O2) corresponding to the plurality of spatial parameters respectively are related, the plurality of spatial parameters are associated with the same codebook type, the plurality of spatial parameters are associated with the same codebook mode, the plurality of spatial parameters are associated with the same frequency domain related parameters, the plurality of spatial parameters are associated with the same codebook restrictions, and the plurality of spatial parameters are associated with the same rank indicator (RI) restrictions.

In accordance with another aspect of the disclosure, a UE in a wireless communication network is provided. The UE includes a transceiver and a controller coupled to the transceiver, wherein the controller is configured to perform the above method performed by the UE.

In accordance with another aspect of the disclosure, a base station in a wireless communication network is provided. The base station includes a transceiver and a controller coupled to the transceiver, wherein the controller is configured to perform the above method performed by the base station.

In accordance with another aspect of the disclosure, One or more non-transitory computer-readable storage media storing one or more computer programs including computer-executable instructions that, when executed by one or more processors of a user equipment (UE), cause the UE to perform operations are provided. The operation include receiving information for configuring channel state information (CSI) report, and determining CSI parameters base on a plurality of first parameter combinations included in the information for configuring CSI report, wherein the first parameter combinations include spatial parameters and/or power parameters, the CSI parameters are in a CSI report, and wherein if the plurality of first parameter combinations include a plurality of spatial parameters, the plurality of spatial parameters satisfy at least one of the following conditions first-dimension parameters (N1) corresponding to the plurality of spatial parameters respectively are related, second-dimension parameters (N2) corresponding to the plurality of spatial parameters respectively are related, products of the first-dimension parameters (N1) corresponding to the plurality of spatial parameters respectively and oversampling parameters (O1) corresponding to the plurality of spatial parameters respectively are related, products of the second-dimension parameters (N2) corresponding to the plurality of spatial parameters respectively and oversampling parameters (O2) corresponding to the plurality of spatial parameters respectively are related, the plurality of spatial parameters are associated with a same codebook type, the plurality of spatial parameters are associated with a same codebook mode, the plurality of spatial parameters are associated with a same frequency domain related parameter, the plurality of spatial parameters are associated with a same codebook restriction, and the plurality of spatial parameters are associated with a same rank indicator (RI) restriction.

This application proposes a series of methods to enable UE to report (a plurality of groups of) CSI parameters obtained based on various parameter combinations in a CSI report. By means of these methods, the base station can obtain CSI parameters corresponding to various parameter combinations through one CSI report, thus improving the scheduling performance of the base station.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above- and other aspects, features, and advantages of certain embodiments of the disclosure will be more apparent from the following description taken in conjunction with the accompanying drawings, in which:

FIG. 1 illustrates an overall structure of an example wireless communication network according to an embodiment of the disclosure;

FIGS. 2A and 2B illustrate a transmission path 200 and a reception path 250 in a wireless communication network according to various embodiments of the disclosure;

FIGS. 3A and 3B illustrate structures of a user equipment (UE) and a base station in a wireless communication network according to various embodiments of the disclosure;

FIG. 4 illustrates a method 400 performed by a UE according to an embodiment of the disclosure;

FIG. 5 illustrates a method 500 performed by a base station according to an embodiment of the disclosure;

FIG. 6 illustrates a structure of a UE 600 according to an embodiment of the disclosure; and

FIG. 7 illustrates a structure of a base station 700 according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and configurations may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, each of such phrases as “A and/or B”, “A or B”, “at least one of A and B”, “at least one of A or B”, “A, B, or C”, “at least one of A, B, and C”, and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

When describing the embodiments of the disclosure, the relevant description of technical contents well known in the art and not directly associated with the disclosure will be omitted. The omission of the unnecessary description is to prevent the main ideas of the disclosure from being obscured and convey the main ideas more clearly.

For the same reason, in the accompanying drawings, some elements may be enlarged, omitted, or schematically illustrated. Moreover, the size of each element does not completely reflect an actual size. In the accompanying drawings, same or corresponding elements have same reference numerals.

The advantages and features of the disclosure and modes for carrying out them will become clear with reference to the embodiments described below in detail in conjunction with the accompanying drawings. However, the disclosure is not limited to the embodiments set forth below and may be implemented in various different forms. The following embodiments are provided merely for the purpose of completely disclosing the disclosure and informing those skilled in the art about the scope of the disclosure, and the scope of the disclosure is merely defined by the appended claims. In the whole specification, same or similar reference numerals denote same or similar elements.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

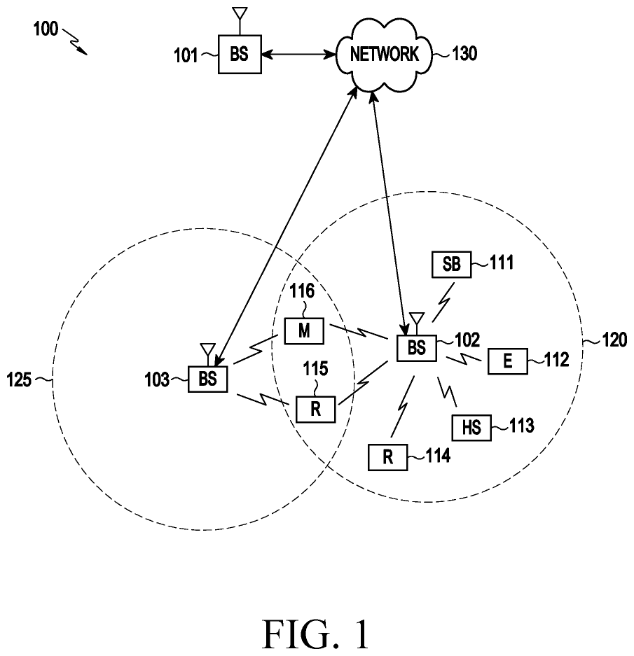

FIG. 1 illustrates an example wireless communication network 100 according to an embodiment of the disclosure.

The embodiment of the wireless communication network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station (BS)” or “access point (AP)” can be used instead of “gNodeB” or “gNB”. For convenience, the terms “gNodeB” and “gNB” are used in this patent document to refer to network infrastructure components that provide wireless access for remote terminals. Moreover, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of user equipments (UEs) within a coverage area 120 of the gNB 102. The first plurality of UEs include a UE 111, which may be located in a Small Business (SB); a UE 112, which may be located in an enterprise (E); a UE 113, which may be located in a wireless fidelity (Wi-Fi) Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. The gNB 103 provides wireless broadband access to network 130 for a second plurality of UEs within a coverage area 125 of the gNB 103. The second plurality of UEs include a UE 115 and a UE 116. In some embodiments, one or more of gNBs 101-103 can communicate with each other and with UEs 111-116 using 5G, Long Term Evolution (LTE), LTE advanced (LTE-A), worldwide interoperability for microwave access (WiMAX) or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a two-dimensional (2D) antenna array as described in embodiments of the disclosure. In some embodiments, one or more of the gNB 101, the gNB 102, and the gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, the gNB 101 can directly communicate with any number of UEs and provide wireless broadband access to the network 130 for those UEs. Similarly, each of the gNBs 102 and 103 can directly communicate with the network 130 and provide direct wireless broadband access to the network 130 for the UEs. In addition, the gNBs 101, 102 and/or 103 can provide access to other or additional external networks, such as external telephone networks or other types of data networks.

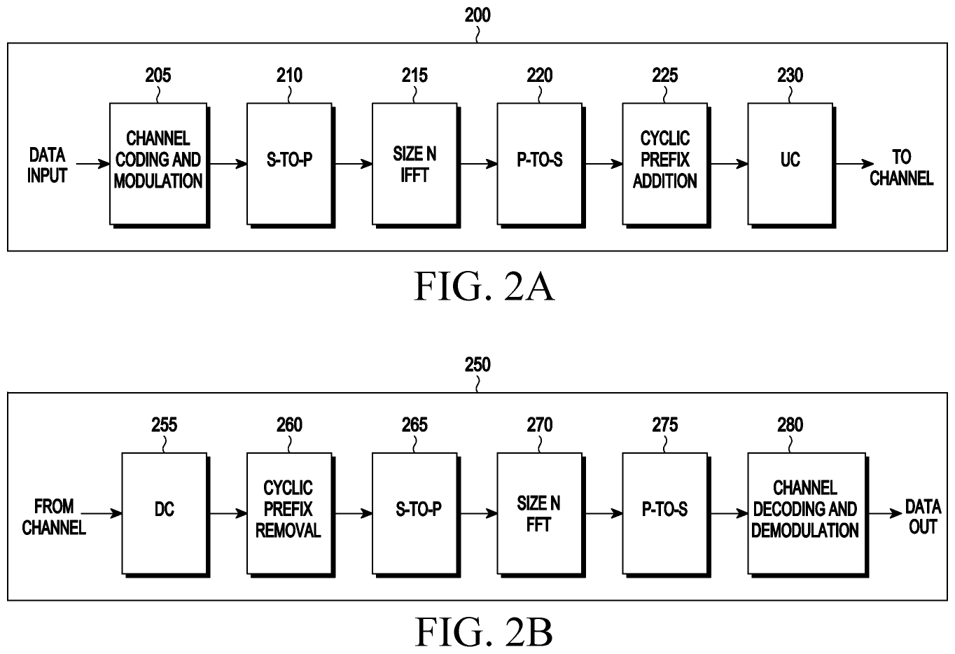

FIGS. 2A and 2B illustrate a transmission path 200 and a reception path 250 in a wireless communication network according to various embodiments of the disclosure. In the following description, the transmission path 200 can be described as being implemented in a gNB, such as the gNB 102, and the reception path 250 can be described as being implemented in a UE, such as the UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in the gNB 102 and the UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to a radio frequency (RF) frequency for transmission via a wireless channel. The signal can also be filtered at a baseband before switching to the RF frequency.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of the gNBs 101-103 may implement a transmission path 200 similar to that for transmitting to the UEs 111-116 in the downlink, and may implement a reception path 250 similar to that for receiving from the UEs 111-116 in the uplink. Similarly, each of the UEs 111-116 may implement a transmission path 200 for transmitting to the gNBs 101-103 in the uplink, and may implement a reception path 250 for receiving from the gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

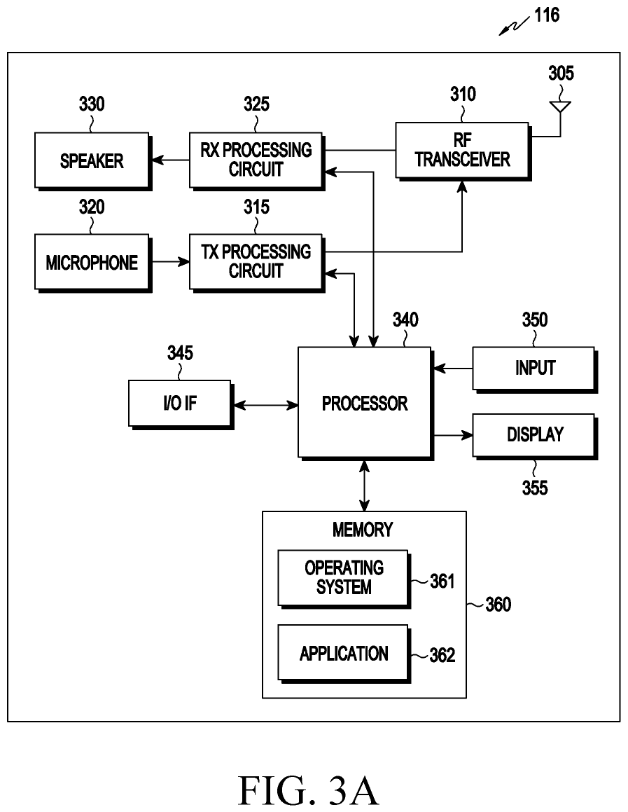

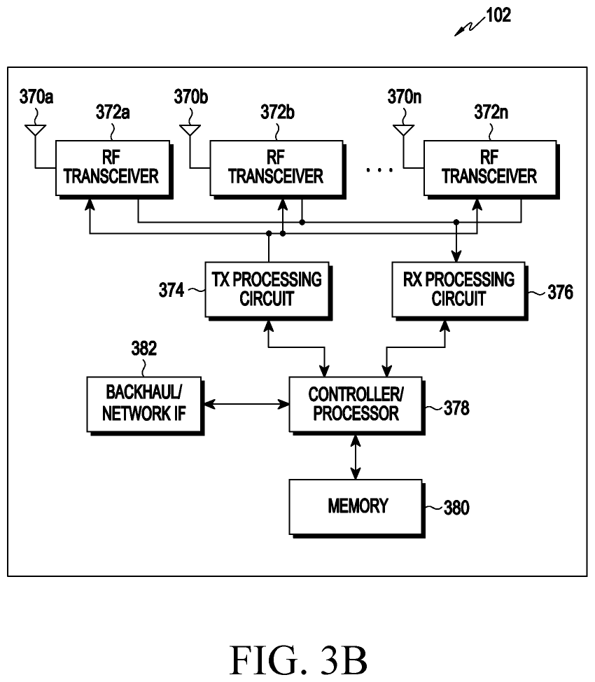

FIG. 3A illustrates an example UE 116 according to an embodiment of the disclosure.

The embodiment of the UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to the speaker 330 (such as for voice data) or to the processor/controller 340 for further processing (such as for web browsing data).

The TX processing circuit 315 receives analog or digital voice data from the microphone 320 or other outgoing baseband data (such as network data, email or interactive video game data) from the processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides the UE 116 with the ability to connect to other devices such as laptop computers and handheld computers. The I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of the UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to an embodiment of the disclosure. The embodiment of the gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that the gNB 101 and the gNB 103 can include the same or similar structures as the gNB 102.

Referring to FIG. 3B, the gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, memory 380, and a backhaul or a network interface 382.

The RF transceivers 372a-372n receive an incoming RF signal from antennas 370a-370n, such as a signal transmitted by UEs or other gNBs. The RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to the controller/processor 378 for further processing.

The TX processing circuit 374 receives analog or digital data (such as voice data, network data, email or interactive video game data) from the controller/processor 378. The TX processing circuit 374 encodes, multiplexes and/or digitizes outgoing baseband data to generate a processed baseband or IF signal. The RF transceivers 372a-372n receive the outgoing processed baseband or IF signal from the TX processing circuit 374 and up-convert the baseband or IF signal into an RF signal transmitted via antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or the network interface 382. The backhaul or network interface 382 allows the gNB 102 to communicate with other devices or systems through a backhaul connection or through a network The backhaul or the network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or the network interface 382 can allow the gNB 102 to communicate with other gNBs through wired or wireless backhaul connections. When the gNB 102 is implemented as an access point, the backhaul or the network interface 382 can allow the gNB 102 to communicate with a larger network, such as the Internet, through a wired or wireless local area network or through a wired or wireless connection. The backhaul or the network interface 382 includes any suitable structure that supports communication through a wired or wireless connection, such as an Ethernet or an RF transceiver

The memory 380 is coupled to the controller/processor 378. A part of the memory 380 can include a RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of the gNB 102 (implemented using the RF transceivers 372a-372n, the TX processing circuit 374 and/or the RX processing circuit 376) support aggregated communication with FDD cells and TDD cells.

Although FIG. 3B illustrates an example of the gNB 102, various changes may be made to FIG. 3B. For example, the gNB 102 can include any number of each component shown in FIG. 3B. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

At present, in a CSI report, a UE can only perform CSI reporting based on one parameter (e.g., power parameter and/or spatial parameter) combination (e.g., hypothesis), which will cause the base station unable to obtain (a set of) CSI parameters corresponding to different parameter combinations in one reporting, and thus a base station cannot decide which parameter combination to use for scheduling.

A further explanation will be provided below based on the attached drawings and specific embodiments.

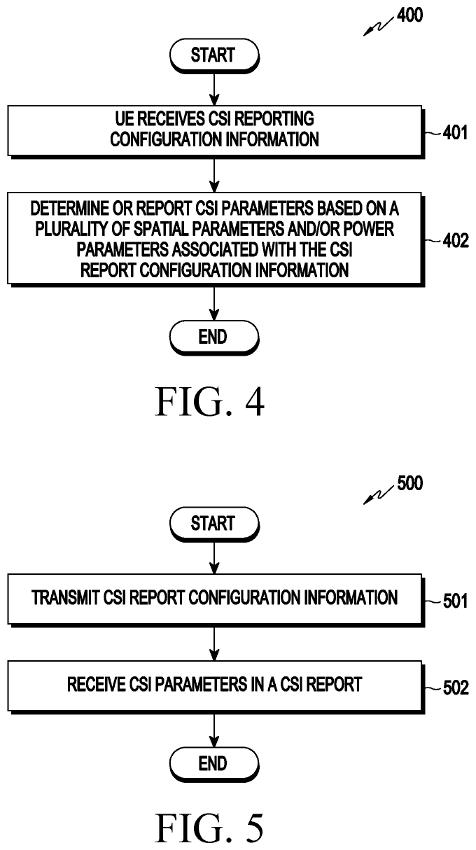

FIG. 4 illustrates a method 400 performed by a user equipment (UE) according to an embodiment of the disclosure.

The method 400 comprises the following operations. Optionally, in operation 401, the UE receives CSI report configuration information. Optionally, the CSI report configuration information may be information (for example, radio resource control (RRC) signaling) for configuring (periodical or semi-persistent or aperiodic) CSI report. For example, the CSI report configuration information is CSI-ReportConfig. Optionally, the CSI report configuration information is associated with spatial information/spatial parameter(s) and/or power information/power parameter(s).

Optionally, the spatial information/spatial parameters comprise/are associated with one or more codebook configuration parameters (e.g., parameters for configuring type I and type II codebooks, CodebookConfig). Optionally, the spatial information comprises/is associated with one or more port (e.g., antenna port) parameters. For example, the antenna port parameters can be used to indicate antenna ports (e.g., indicating the number of the antenna ports). For example, the antenna port parameter can be used to indicate the number of antenna ports in a first-dimension (N1) and in a second-dimension (N2) and/or codebook subset restriction. For example, the codebook subset restriction may be for a single-panel codebook and/or a multi-panel codebook. For example, the reference signal (e.g., channel state information-reference signal (CSI-RS)) port parameter can be used to indicate reference signal port information (e.g., port number and/or the number of reference signal ports). Optionally, the spatial information/spatial parameters comprise/are associated with one or more reference signal port parameters (or reference signal port information). For example, the reference signal (e.g., CSI-RS or SSB) port parameter can be used to indicate one or more reference signal port numbers. Optionally, the indicated reference signal port number may be based on a reference signal port number that a reference signal (or reference signal resource) has. For example, the reference signal port number indicated by the reference signal port parameter may be all or a subset of the reference signal port numbers that the reference signal (or reference signal resource) has. Here, the port number that the reference signal has is related to a port number parameter (for example, nrofPorts). For example, when a CSI-RS resource is configured with a port number parameter (nrofPorts) of 8, the CSI-RS resource has 8 ports with port numbers starting from 3000, that is, 3000+i, where the value range of i is {0, 1, 2, . . . , K−1}, and K is equal to the number corresponding to the port parameter. In this example, the port numbers for the CSI resource are 3000, 3001, 3002, . . . , 3007. The reference signal port parameters may indicate a part of these ports. Optionally, the reference signal port parameter indicates the port number or indicates the number of ports (for example, by the method of a bitmap). For example, the reference signal port parameter (directly) indicates port numbers 3001 and 3002. Optionally, the reference signal port parameter comprises a bitmap with bits which is equal to the number of CSI-RS ports that the CSI-RS resource has. The bits of the bitmap are mapped according to the increasing/decreasing order of values of the reference signal port numbers that the CSI-RS resource has. When the bit in the bitmap is “1”, it means the corresponding port is indicated; and when the bit in the bitmap is “0”, it means that the corresponding port is not indicated. For example, when the bitmap is “01100000”, the reference signal port parameter (directly) indicates the port numbers 3001 and 3002. Optionally, the reference signal port parameter comprises a port index list. Each item in the port index list represents a CSI-RS port. For another example, the reference signal port parameter indicates the number (J) of ports, that is, 3000+j or j, where the value range of j is {0, 1, 2, . . . , J−1}, and J is equal to the number indicated by the reference signal port parameter. Optionally, J is less than or equal to K. Optionally, when determining/calculating the CSI parameters, the UE renumbers the indicated port numbers (as the indication method described above). Optionally, when determining/calculating the CSI parameters, the UE renumbers the indicated port numbers based on the increasing order of values (from small to large) of the indicated port numbers (as the indication method described above). Optionally, when determining/calculating the CSI parameters, the UE determines the CSI parameters based on the renumbered port numbers. For example, when the indicated port numbers of the reference signal resource are 3001, 3002, 3005 and 3006, these four ports will be renumbered according to the increasing order of the values of the ports. 3001 is numbered as 3000, 3002 is numbered as 3001, 3005 is numbered as 3002, and 3006 is numbered as 3003. Here, the spatial parameters are taken as reference signal ports, and the spatial parameters can also be reference signal code division multiplexing (CDM) groups (or ports associated with CDM groups) and reference signal port groups. The application is not limited thereto. Optionally, the spatial information/spatial parameters comprise/are associated with one or more port parameters/port indication information. For example, the port parameter/port indication may be port indication used for RI and/or CQI calculation, for example, non-PMI-PortIndication.

Optionally, the UE determines the CSI parameters according to the spatial parameters/spatial information (associated with CSI report). For example, the UE determines the CSI parameters based on codebook configuration information related to the spatial parameters associated with CSI report and/or reference signal ports. The CSI parameters may comprise at least one of CQI index, PMI and RI, LI, layer 1-reference signal received power (L1-RSRP), and layer 1-signal interference noise ratio (L1-SINR). Optionally, determining the CSI parameters can involve determining CSI feedback. Determining the CSI parameters can also involve determining a report carrying the CSI parameters (i.e., determining the CSI report). Optionally, the CSI parameters can be CSI feedback. The CSI parameters can also be the report carrying the CSI parameters (i.e., CSI report).

Optionally, the power information/power parameters comprise/are associated with absolute power information/power parameters. The power parameters/power information comprises/is associated with one or more power offset parameters. For example, the power offset parameters are power offset parameters (e.g., powerControlOffset) of a physical downlink shared channel (PDSCH) resource element (RE) and a non-zero power (NZP) channel state information reference signal resource element (CSI-RS RE). For example, the power offset parameters are power offset parameters (e.g., powerControlOffsetSS) of a non-zero power (NZP) channel state information reference signal resource element (CSI-RS RE) and a secondary synchronization signal resource element (SSS RE). Optionally, the power information comprises/is associated with one or more power offset adjustment parameters (related to the change/increment/adjustment of power offset).

Optionally, the UE determines the CSI parameters (associated with CSI report) according to the power parameter and/or the power offset adjustment parameter. For example, the UE determines the CSI parameters according to a sum of the power parameter (e.g., powerControlOffset) and the power offset adjustment parameter. Optionally, determining the CSI parameters can involve determining CSI feedback. Determining the CSI parameters can also involve determining a report that carries the CSI parameters (that is, determining the CSI report). Optionally, the CSI parameter may be CSI feedback. The CSI parameter can also be a report that carries the CSI parameter (that is, CSI report).

Optionally, the CSI report configuration information is associated with a plurality of spatial parameters and/or power parameters. Optionally, the multiple spatial parameters and/or power parameters associated with the CSI report configuration information refer to at least one of the following: a plurality of power parameters and/or a spatial parameter; a power parameter and/or a plurality of spatial parameters; a plurality of power parameters and/or a plurality of spatial parameters; a plurality of power parameters; and a plurality of spatial parameters.

The plurality of spatial parameters may be a plurality of codebook parameters. For example, the plurality of codebook parameters refer to a plurality of codebook configuration parameters (e.g., codebookConfig). For example, the (above-mentioned) CSI report configuration information comprises a plurality of codebook configuration parameters. Each of the plurality of codebook configuration parameters is associated with/comprises at least one of the following: a first-dimension number (N1) and a corresponding oversampling parameter (O1); a second-dimension number (N2) and a corresponding oversampling parameter (O2); codebook restrictions; codebook types; codebook modes; frequency domain features; and RI restrictions. Optionally, the codebook types comprise a type I codebook and a type II codebook. Optionally, the type I codebook may comprise (subtype) a type I single-panel codebook and a type I multi-panel codebook. Optionally, the type II codebook may comprise (subtype) a type II codebook and a type II port selection codebook. Optionally, the codebook modes comprise mode I and mode II. Optionally, the frequency domain features comprise frequency domain granularity (parameters) and/or subbands (parameters). Optionally, the codebook restriction may be a bitmap parameter. Bitmap parameters (e.g., n1-n2) form the bit sequence a_{A}_{_{c}}₋₁, . . . , a₁, a₀, where a₀ is the LSB and a_{A}_{_{c}}₋₁ is the MSB, and where a bit value of zero indicates that PMI report is not allowed to correspond to any precoder associated with the bit. The number of bits is given by A_{c}=N₁O₁N₂O₂. Optionally, a_{N}_{₂}_{O}_{₂}ₗ₊ₘ is associated with all precoders based on the quantity v_{l,m}, l=0, . . . , N₁O₁−1, m=0, . . . , N₂O₂−1. Optionally, the codebook restrictions may also be codebook limit parameters. Optionally, the codebook restriction parameters are, for example, a first-dimension antenna port number, a second-dimension antenna port number and a codebook subset restriction parameter (n1-n2-codebook subset restriction). The codebook restriction parameter is, for example, a parameter for codebook subset restriction of a two-transmitting antenna (2TX) codebook (twoTX-CodebookSubsetRestriction). The codebook restriction parameter is, for example, a parameter for codebook subset restriction of an i2 codebook (of a type I codebook) (typel-SinglePanel-codebook SubsetRestriction-i2). Optionally, the plurality of spatial parameters satisfy at least one of the following conditions/restrictions.

First-dimension parameters (N1) corresponding to the plurality of spatial parameters respectively are related. For example, the N₁ values associated with/corresponding to the plurality of codebook parameters are equal. For example, the N₁ values associated with/corresponding to the plurality of codebook parameters have an integer multiple (or multiple or double or power of 2 multiple) relationship. For example, the N₁ values associated with/corresponding to any two of the plurality of codebook parameters have an integer multiple (or multiple or double or power of 2 multiple) relationship. For example, the N₁ values corresponding to the plurality of codebook parameters Codebook #1, Codebook #2, and Codebook #3 are 2, 4, and 8 respectively. The N₁ values of these codebook parameters have an integer multiple (or multiple or double or power of 2 multiple) relationship.

Second-dimension parameters (N₂) corresponding to the plurality of spatial parameters respectively are related. For example, the N₂ values associated with/corresponding to the plurality of codebook parameters are equal. For example, the N₂ values associated with/corresponding to the plurality of codebook parameters have an integer multiple (or multiple or double or power of 2 multiple) relationship. For example, the N₂ values associated with/corresponding to any two of the plurality of codebook parameters have an integer multiple (or multiple or double or power of 2 multiple) relationship. For example, the N₂ values corresponding to the plurality of codebook parameters Codebook #1, Codebook #2, and Codebook #3 are 2, 4, and 8 respectively. The N₂ values of these codebook parameters have an integer multiple (or multiple or double or power of 2 multiple) relationship.

Products of the first-dimension parameters (N₁) and oversampling parameters (O₁) corresponding to the plurality of spatial parameters respectively are related. For example, the products (N₁*O₁) of N₁ and oversampling parameters (O₁) associated with/corresponding to the plurality of codebook parameters are equal. For example, the N₁*O₁ values associated with/corresponding to the plurality of codebook parameters have an integer multiple (or multiple or double or power of 2 multiple) relationship. For example, the N₁*O₁ values associated with/corresponding to any two of the plurality of codebook parameters have an integer multiple (or multiple or double or power of 2 multiple) relationship. For example, the N₁ values corresponding to the plurality of codebook parameters Codebook #1, Codebook #2, and Codebook #3 are 2, 4, and 8 respectively, and corresponding O1 values are 4, 4, and 4 respectively. The N₁*O₁ values of these codebook parameters have an integer multiple (or multiple or double or power of 2 multiple) relationship.

Products of the second-dimension parameters (N₂) and oversampling parameters (O₂) corresponding to the plurality of spatial parameters respectively are related. For example, the products (N₂*O₂) of N₂ and oversampling parameters (O₂) associated with/corresponding to the plurality of codebook parameters are equal. For example, the N₂*O₂ values associated with/corresponding to the plurality of codebook parameters have an integer multiple (or multiple or double or power of 2 multiple) relationship. For example, the N₂*O₂ values associated with/corresponding to any two of the plurality of codebook parameters have an integer multiple (or multiple or double or power of 2 multiple) relationship. For example, the N₂ values corresponding to the plurality of codebook parameters Codebook #1, Codebook #2, and Codebook #3 are 2, 4, and 8 respectively, and corresponding O₂ values are 4, 4, and 4 respectively. The N₂*O₂ values of these codebook parameters have an integer multiple (or multiple or double or power of 2 multiple) relationship.

The plurality of spatial parameters are associated with the same codebook type (e.g., codebook type parameter). For example, the types or subtypes associated with/corresponding to the plurality of codebook parameters are the same. For example, the plurality of codebook parameters are all associated with/correspond to a type I single-panel codebook.

The plurality of spatial parameters are associated with the same codebook mode (e.g., codebook mode parameter). For example, the codebook modes associated with/corresponding to the plurality of codebook parameters are the same. For example, the plurality of codebook parameters are all associated with/correspond to mode I. For example, the plurality of codebook parameters are all associated with/correspond to mode II.

The plurality of spatial parameters are associated with the same frequency domain features (i.e., parameters related to the frequency domain). For example, the frequency domain granularities associated with/corresponding to the plurality of codebook parameters are the same. For example, the plurality of codebook parameters are all associated with/correspond to a wideband frequency domain granularity. For example, the plurality of codebook parameters are all associated with/correspond to a subband granularity. For example, the plurality of codebook parameters are all associated with/correspond to both the wideband granularity and the subband granularity. For example, frequency domain granularity parameters (e.g., pmi-FormatIndicator, or cqi-FormatIndicator) associated with/corresponding to the plurality of codebook parameters are the same. For example, subbands (subsets) associated with/corresponding to the plurality of codebook parameters are the same. For example, parameters (csi-ReportingBand) associated with/corresponding to the plurality of codebook parameters and used for indicating CSI report subbands (subsets) are the same.

The plurality of spatial parameters are associated with the same RI restrictions. For example, rank restrictions associated with/corresponding to the plurality of codebook parameters are the same. For example, the plurality of codebook parameters are all associated with/correspond to the same RI restrictions. For example, the plurality of codebook parameters are all associated with/correspond to the same RI restriction parameters. Here, the RI restriction parameters may be restriction parameters for a type I single-panel codebook typel-SinglePanel-ri-Restriction. Here, the RI restriction parameters may be rank restriction parameters for a type I multi-panel codebook ri-Restriction. Here, the RI restriction parameters may be rank restriction parameters for a type II port selection codebook typeII-PortSelectionRI-Restriction. Here, the RI restriction parameters may be rank restriction parameters for a type II codebook typeII-RI-Restriction.

The codebook restrictions of the plurality of spatial parameters are associated, that is, the plurality of spatial parameters are associated with the same codebook restrictions (e.g., codebook constraint parameters). For example, codebook restriction parameters associated with/corresponding to the plurality of codebook parameters are the same. For example, codebook restrictions associated with/corresponding to the plurality of codebook parameters are the same. For example, when the first-dimension numbers (N₁) and the second-dimension numbers (N₂) of at least two codebook parameters among the plurality of codebook parameters are the same, the values of the bitmaps (used to indicate codebook restrictions) corresponding to the at least two codebook parameters are the same (for example, bits of these bitmaps are one-to-one mapped and have the same value). For example, the bitmaps corresponding to (any) two codebook parameters among the plurality of codebook parameters for indicating codebook restrictions are denoted as a_{N}_{₂}_{O}_{₂}ₗ₊ₘ and a′_{N′}_{₂}_{O′}_{₂}_{l′+m′}. The first-dimension numbers (N₁) corresponding to the two codebook parameters are N₁ and N′₁ respectively. The second-dimension numbers (N₂) corresponding to the two codebook parameters are N₂ and N′₂ respectively. The first-dimension oversampling parameters (O₁) corresponding to the two codebook parameters are O₁ and O′₁ respectively. The second-dimension numbers (O₂) corresponding to the two codebook parameters are O₂ and O′₂ respectively. Precoding vectors corresponding to the two codebook parameters are v_{l,m} and v′_{l′,m′}, respectively. Here, l=0, . . . , N₁O₁−1, m=0, . . . , N₂O₂−1. Here, l′=0, . . . , N′₁O′₁−1, m′=0, . . . , N′₂O′₂−1. Optionally, N₁ is greater than or equal to N′₁, the ratio of N₁ to N′₁ is \hat{p}, N′₂ is greater than or equal to N₂, and the ratio of N₂ to N′₂ is q. Optionally, O₁=O′₁; O₂=O′₂. Optionally, \hat{p} is a power of 2. For example, \hat{p} is at least one of 1, 2, 4 and 8. Optionally, \hat{q} is a power of 2. For example, \hat{q} is at least one of 1, 2, 4 and 8. When \hat{p}=1 (that is, N₁=N′₁) and \hat{q}=1 (that is, N₂=N′₂), the values of bits corresponding to a_{N}_{₂}_{O}_{₂}ₗ₊ₘ and a′_{N′}_{₂}_{O′}_{₂}_{l′+m′} are one-to-one mapped in sequential order and are equal. For another example, a_{N}_{₂}_{O}_{₂}ₗ₊ₘ and a′_{N′}_{₂}_{O′}_{₂}_{l′+m′} are related (with a specific restrictive relationship). For example, when at least one of the following conditions is met, the bits of a′_{N′}_{₂}_{O′}_{₂}_{l′+m′} corresponding to v′_{l′,m′} and a_{N}_{₂}_{O}_{₂}ₗ₊ₘ corresponding to v_{l,m} are associated.

$$\begin{matrix}\hat{p} {l}^{′} + {k}_{3} = l ; \\ \hat{q} {m}^{′} + {k}_{4} = m ; \\ ( \hat{p} {l}^{′} + {k}_{3} ) mod {N}_{1} {O}_{1} = l ; \\ ( \hat{q} {m}^{′} + {k}_{4} ) mod {N}_{2} {O}_{2} = m ; \\ [ {N}_{2}^{′} {O}_{2}^{′} ( \hat{p} {l}^{′} + {k}_{3} ) + ( \hat{q} {m}^{′} + {k}_{4} ) ] mod {N}_{1} {O}_{1} {N}_{2} {O}_{2} = {N}_{2} {O}_{2} l + m .\end{matrix}$$

When v′_{l′,m′} (or a′_{N′}_{₂}_{O′}_{₂}_{l′+m′}) is associated with at least one bit (corresponding to v_{l,m} or a_{N}_{₂}_{O}_{₂}ₗ₊ₘ) and at least one of them is zero, the bit corresponding to a′_{N′}_{₂}_{O′}_{₂}_{l′+m′} my is also zero. Optionally, k1 is predefined. For example, k3=0. For example, k3=0, 1. For example, k3=0, 1, 2. Optionally, k3 is based on \hat{p}. For example, k3=0, 1, . . . , \hat{p}/2. For example, k3=0, 1, . . . , ceiling (\hat{p}/2). For example, k3=0, 1, . . . , floor (\hat{p}/2). Optionally, k4 is predefined. For example, k4=0. For example, k4=0, 1. For example, k4=0, 1, 2. Optionally, k4 is based on q. For example, k4=0, 1, . . . , \hat{q}/2. For example, k4=0, 1, . . . , ceiling (\hat{q}/2). For example, k4=0, 1, . . . , floor (\hat{q}/2). See Equation 1 for the definition of v_{l,m}. See Equation 1 for the definition of \tilde{v}_{l,m}. Optionally, the codebook restriction associated with a second spatial parameter is based on v′_{l′,m′}, l′=0, . . . , N′₁O′₁−1 and m′=0, . . . , N′₂O′₂−1. The definition of v′_{l′,m}, is the same as that of v_{l,m}, except that N₁ is replaced by N′₁, N₂ is replaced by N′₂, O₁ is replaced by O′₁, and O₂ is replaced by O′₂. The definition of \tilde{v}′_{l′,m′}, is the same as that of \tilde{v}_{l,m}, except that N₁ is replaced by N′₁, N₂ is replaced by N′₂, O₁ is replaced by O′₁, and O₂ is replaced by O′₂. Here, the advantage of using the same/similar codebook restrictions for multiple spatial parameters is that it can avoid the inconsistency or contradiction of CSI parameters obtained based on multiple spatial parameters, and improve the accuracy of CSI report.

Optionally, the plurality of spatial parameters may comprise/be associated with a codebook parameter (e.g., codebook configuration parameter) and one or more second spatial parameters. Optionally, the one or more second spatial parameters can be understood as being one-to-one mapped with one or more other codebook parameters except the said codebook parameter, and the one or more second spatial parameters are a part of the one or more other codebook parameters. For example, one (e.g., a first) spatial parameter among the plurality of spatial parameters may comprise/be associated with a codebook parameter. Other spatial parameters among the plurality of spatial parameters (for example, spatial parameters other than the first spatial parameter) are associated with or correspond to one or more second spatial parameters. Optionally, the one or more second spatial parameters can be understood as being one-to-one mapped with one or more codebook parameters, and the one or more second spatial parameters are a part of the one or more codebook parameters. Optionally, the plurality of spatial parameters and the plurality of second spatial parameters are one-to-one mapped. For example, one (e.g., the first) spatial parameter among the plurality of spatial parameters may comprise/be associated with a codebook parameter and one (e.g., a first) second spatial parameter among the one or more second spatial parameters. One (e.g., a second) spatial parameter among the plurality of spatial parameters may comprise/be associated with the said codebook parameter and one (e.g., a second) second spatial parameter among the one or more second spatial parameters, and so on, that is, the plurality of spatial parameters may be determined based on one codebook parameter and one or more second spatial parameters associated with the codebook parameter. For example, the (above-mentioned) CSI report configuration information contains a codebook parameter and one or more second spatial parameters. The codebook configuration parameters are associated with/comprise at least one of the following: a first-dimension number (N1) and a corresponding oversampling parameter (O1); a second-dimension number (N2) and a corresponding oversampling parameter (O2); codebook restrictions; codebook types; codebook modes; frequency domain features; and RI restrictions. Optionally, the codebook types comprise a type I codebook and a type II codebook. Optionally, the type I codebook may comprise (subtype) a type I single-panel codebook and a type I multi-panel codebook. Optionally, the type II codebook may comprise (subtype) a type II codebook and a type II port selection codebook. Optionally, the codebook modes comprise mode I and mode II. Optionally, the frequency domain features comprise frequency domain granularity (parameters) and/or subbands (parameters). Optionally, the codebook restriction may be a bitmap parameter. Here, the second spatial parameter is associated with or comprises at least one of the following: a first-dimension number (N1) and/or a corresponding oversampling parameter (O1); a second-dimension number (N2) and/or a corresponding oversampling parameter (O2); and codebook subset restrictions. Optionally, a plurality of spatial parameters (e.g., spatial parameters other than the first spatial parameter) are based on a codebook parameter and/or one or more second spatial parameters. Optionally, the first-dimension numbers associated with the codebook parameters are greater than or equal to the first-dimension parameters associated with (all) the second spatial parameters. Optionally, the second-dimension numbers associated with the codebook parameters are greater than or equal to the second-dimension parameters associated with (all) the second spatial parameters. Optionally, the first-dimension numbers associated with the codebook parameters are smaller than or equal to the first-dimension parameters associated with (all) the second spatial parameters. Optionally, the second-dimension numbers associated with the codebook parameters are smaller than or equal to the second-dimension parameters associated with (all) the second spatial parameters. Optionally, a plurality of spatial parameters (for example, (each) of the plurality of spatial parameters, or (each) of the spatial parameters other than the first spatial parameter) are determined based on codebook parameters and/or one or more second spatial parameters, and the specific determination method is as follows.

### Method I

Oversampling parameters associated with spatial parameters are determined based on codebook parameters and second spatial parameters. Optionally, the second spatial parameter comprises a first-dimension number and/or a second-dimension number. Optionally, first-dimension oversampling parameters associated with the spatial parameters are determined based on a product of first-dimension numbers and first-dimension oversampling parameters associated with the codebook parameters, as well as first-dimension numbers in the second spatial parameters. Optionally, second-dimension oversampling parameters associated with the spatial parameters are determined based on a product of second-dimension numbers and second-dimension oversampling parameters associated with the codebook parameters, as well as second-dimension numbers in the second spatial parameters. Optionally, products of the first-dimension numbers and the corresponding oversampling parameters associated with the spatial parameters are equal. Optionally, products of the second-dimension numbers and the corresponding oversampling parameters associated with the spatial parameters are equal. For example, the plurality of spatial parameters comprise two spatial parameters, which are associated with a codebook parameter and a second spatial parameter. One (e.g., a first) parameter in a plurality of spatial domains determines a corresponding spatial parameter based on codebook parameters. One (e.g., a second) parameter among the plurality of spatial parameters determines a corresponding spatial parameter (first-dimension oversampling parameter) based on codebook parameters and second spatial parameters. The first-dimension number associated with the codebook parameter is 8, and the first-dimension oversampling parameter is 4. In the second spatial parameter, if the first-dimension number is 4, the first-dimension oversampling number associated with the spatial parameter is 8*4/4=8.

### Method II

First-dimension numbers and/or the second-dimension numbers associated with spatial parameters are determined based on codebook parameters and/or second spatial parameters. Optionally, the codebook parameters comprise the first-dimension numbers and/or the second-dimension numbers. For example, the first-dimension numbers and/or the second-dimension numbers associated with the spatial parameters are equal to first-dimension numbers and/or second-dimension numbers included in the codebook parameters. Optionally, the second spatial parameter comprises a first-dimension number and/or a second-dimension number. For example, the first-dimension numbers and/or the second-dimension numbers associated with the spatial parameters are equal to first-dimension numbers and/or second-dimension numbers included in the second spatial parameters.

### Method III

Codebook types associated with spatial parameters are determined based on codebook parameters or second spatial parameters. For example, the plurality of spatial parameters comprise two spatial parameters, which are associated with a codebook parameter and/or a second spatial parameter. One (e.g., a first) parameter in a plurality of spatial domains determines a corresponding spatial parameter based on the codebook parameters and/or the second spatial parameters. One (e.g., a second) spatial parameter among the plurality of spatial parameters is determined based on the codebook types of (corresponding to) the codebook parameters or the second spatial parameters. The codebook type of one (e.g., a second) spatial parameter among the plurality of spatial parameters is the same as that of (corresponding to) the codebook parameter or the second spatial parameter.

### Method IV

Codebook modes associated with spatial parameters are determined based on codebook parameters or second spatial parameters. For example, the plurality of spatial parameters comprise two spatial parameters, which are associated with a codebook parameter and a second spatial parameter. One (e.g., a first) parameter in a plurality of spatial domains determines a corresponding spatial parameter based on the codebook parameters and/or the second spatial parameters. One (e.g., a second) spatial parameter among the plurality of spatial parameters is determined based on the codebook modes of (corresponding to) the codebook parameters or the second spatial parameters. The codebook mode of one (e.g., a second) spatial parameter among the plurality of spatial parameters is the same as that of (corresponding to) the codebook parameter or the second spatial parameter.

### Method V

Frequency domain granularities associated with spatial parameters are determined based on codebook parameters or second spatial parameters. For example, the plurality of spatial parameters comprise two spatial parameters, which are associated with a codebook parameter and a second spatial parameter. One (e.g., a first) parameter in a plurality of spatial domains determines a corresponding spatial parameter based on the codebook parameters and/or the second spatial parameters. One (e.g., a second) spatial parameter among the plurality of spatial parameters is determined based on the frequency domain granularities (or frequency domain granularity parameters) of (corresponding to) the codebook parameters or the second spatial parameters. The frequency domain granularity (or frequency domain granularity parameter) of one (e.g., the second) spatial parameter among the plurality of spatial parameters is the same as the frequency domain granularity (or frequency domain granularity parameter) of (corresponding to) the codebook parameter or the second spatial domain parameter.

### Method VI

RI restrictions associated with spatial parameters are determined based on codebook parameters or second spatial parameters. For example, the plurality of spatial parameters comprise two spatial parameters, which are associated with a codebook parameter and a second spatial parameter. One (e.g., a first) parameter in a plurality of spatial domains determines a corresponding spatial parameter based on the codebook parameters and/or the second spatial parameters. One (e.g., a second) spatial parameter among the plurality of spatial parameters is determined based on the RI restrictions (or RI restriction parameters) of (corresponding to) the codebook parameters or the second spatial parameters. The RI restriction (or RI restriction parameter) of one (e.g., the second) spatial parameter among the plurality of spatial parameters is the same as the RI restriction (or RI restriction parameter) of (corresponding to) the codebook parameter or the second spatial domain parameter.

### Method VII

Codebook restrictions associated with spatial parameters are determined based on codebook parameters and/or second spatial parameters. For example, the plurality of spatial parameters comprise two spatial parameters, which are associated with a codebook parameter and a second spatial parameter. One (e.g., a first) parameter in a plurality of spatial domains determines a corresponding spatial parameter based on codebook parameters. One (e.g., a second) spatial parameter among the plurality of spatial parameters is determined based on the codebook restrictions (or codebook restriction parameters) of (corresponding to) the codebook parameters and/or the second spatial parameters. The codebook restriction of the spatial parameter (for example, the second spatial parameter) is determined as follows.

### Method I

The codebook restriction associated with/included in the second spatial parameter is the same as that associated with the codebook parameter. For example, when the first-dimension numbers (N1) associated with/included in the codebook parameter and the second spatial parameter are the same, and the second-dimension numbers (N2) associated with/included in the plurality of codebook parameters and the second spatial parameter are also the same, the values of the bitmaps associated with the spatial parameters (for indicating codebook restrictions) are the same as those associated with the codebook parameters (for indicating codebook restrictions), for example, bits of these bitmaps are one-to-one mapped and have the same value.

### Method II

The codebook restriction associated with/included in the second spatial parameter is determined according to the codebook restriction associated with the codebook parameter. For example, when the first-dimension numbers (N1) associated with/included in the codebook parameter and the second spatial parameter have a multiple relationship (e.g., a multiple of 2, a multiple of a power of 2), and the second-dimension numbers (N2) associated with/included in the codebook parameter and the second spatial parameter also have a multiple relationship (e.g., a multiple of 2, a multiple of a power of 2), the codebook restriction associated with/included in the codebook parameter can be a bitmap parameter. Optionally, the codebook restriction associated with the codebook parameter is a_{N}_{₂}_{O}_{₂}ₗ₊ₘ. a_{N}_{₂}_{O}_{₂}ₗ₊ₘ is associated with all precoders based on the quantity v_{l,m}, l=0, . . . , N₁O₁−1, m=0, . . . , N₂O₂−1. See Equation 1 for the definition of v_{l,m}. See Equation 1 or the definition of \tilde{v}_{l,m}. Optionally, the codebook restriction associated with the second spatial parameter is based on v′_{l′,m′}, l′=0, . . . , N′₁O′₁−1 and m′=0, . . . , N′₂O′₂−1. The definition of v′_{l′,m′} is the same as that of v_{l,m}, except that N₁ is replaced by N′₁, N₂ is replaced by N′₂, O₁ is replaced by O′₁, and O₂ is replaced by O′₂. The definition of \tilde{v}′_{l′,m′} is the same as that of \tilde{v}_{l,m}, except that N₁ is replaced by N′₁, N₂ is replaced by N′₂, O₁ is replaced by O′₁, and O₂ is replaced by O′₂. Optionally, N₁ is greater than or equal to N′₁, the ratio of N₁ to N′₁ is p, N′₂ is greater than or equal to N₂, and the ratio of N₂ to N′₂ is \hat{q}. Optionally, O₁=O′₁; O₂=O′₂. Optionally, \hat{p} is a power of 2. For example, \hat{p} is at least one of 1, 2, 4 and 8. Optionally, \hat{q} is a power of 2. For example, \hat{q} is at least one of 1, 2, 4 and 8.

Optionally, whether PMI report is allowed is based on the correlation between v′_{l,m} and a_{N}_{₂}_{O}_{₂}ₗ₊ₘ. For example, when at least one of the following conditions is met, the bits of a_{N}_{₂}_{O}_{₂}ₗ₊ₘ corresponding to v′_{l′,m′} and v_{l,m} are associated.

$$\begin{matrix}\hat{p} {l}^{′} + {k}_{3} = l ; \\ \hat{q} {m}^{′} + {k}_{4} = m ; \\ ( \hat{p} {l}^{′} + {k}_{3} ) mod {N}_{1} {O}_{1} = l ; \\ ( \hat{q} {m}^{′} + {k}_{4} ) mod {N}_{2} {O}_{2} = m ; \\ [ {N}_{2}^{′} {O}_{2}^{′} ( \hat{p} {l}^{′} + {k}_{3} ) + ( \hat{q} {m}^{′} + {k}_{4} ) ] mod {N}_{1} {O}_{1} {N}_{2} {O}_{2} = {N}_{2} {O}_{2} l + m .\end{matrix}$$

When v′_{l′,m′} is associated with at least one bit and at least one of them is zero, PMI report is not allowed to correspond to any precoder based on v′_{l′,m′}. Optionally, k₃ is predefined. For example, k₃=0. For example, k₃=0, 1. For example, k₃=0, 1, 2. Optionally, k₃ is based on \hat{p}. For example, k₃=0, 1, . . . , \hat{p}/2. For example, k3=0, 1, . . . , ceiling (\hat{p}/2). For example, k₃=0, 1, . . . , floor (\hat{p}/2). Optionally, k₄ is predefined. For example, k₄=0. For example, k₄=0, 1. For example, k₄=0, 1, 2. Optionally, k₄ is based on \hat{q}. For example, k₄=0, 1, . . . , \hat{q}/2. For example, k4=0, 1, . . . , ceiling (\hat{q}/2). For example, k₄=0, 1, . . . , floor (\hat{q}/2).

Optionally, whether PMI report is allowed is based on the correlation between \tilde{v}′_{l′,m}, and a_{N}_{₂}_{O}_{₂}ₗ₊ₘ. For example, when at least one of the following conditions is met, the bits of a_{N}_{₂}_{O}_{₂}ₗ₊ₘ corresponding to \tilde{v}′_{l′,m}′ and v_{l,m} are associated.

$$\begin{matrix}2 \hat{p} {l}^{′} + {k}_{5} = l ; \\ \hat{q} {m}^{′} + {k}_{4} = m ; \\ ( 2 \hat{p} {l}^{′} + {k}_{5} ) mod {N}_{1} {O}_{1} = l ; \\ ( \hat{q} {m}^{′} + {k}_{4} ) mod {N}_{2} {O}_{2} = m ; \\ [ {N}_{2}^{′} {O}_{2}^{′} ( \hat{p} {l}^{′} + {k}_{3} ) + ( \hat{q} {m}^{′} + {k}_{4} ) ] mod {N}_{1} {O}_{1} {N}_{2} {O}_{2} = {N}_{2} {O}_{2} l + m .\end{matrix}$$

When v′_{l′,m′} is associated with at least one bit and at least one of them is zero, PMI report is not allowed to correspond to any precoder based on v′_{l′,m′}. Optionally, k₅ is predefined. For example, k₅=0. For example, k₅=0, 1. For example, k₅=0, 1, 2. Optionally, k₅ is based on \hat{p}. For example, k₅=0, 1, . . . , \hat{p}. Optionally, k₄ is predefined. For example, k₄=0. For example, k₄=0, 1. For example, k₄=0, 1, 2. Optionally, k₄ is based on q. For example, k₄=0, 1, . . . , \hat{q}/2. For example, k4=0, 1, . . . , ceiling (\hat{q}/2). For example, k₄=0, 1, . . . , floor (\hat{q}/2).

$$\begin{matrix}{u}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ]\end{matrix} & {N}_{2} > 1 \\ 1 & {N}_{2} = 1\end{matrix} \\ {v}_{l , m} = [ \begin{matrix}{u}_{m} & {e}^{j \frac{2 π l}{{O}_{1} {N}_{1}}} {u}_{m} & … & {{e}^{j \frac{2 π l ( {N}_{1} - 1 )}{{O}_{1} {N}_{1}}} {u}_{m} ]}^{T}\end{matrix} \\ {\tilde{v}}_{l , m} = [ \begin{matrix}{u}_{m} & {e}^{j \frac{4 π l}{{O}_{1} {N}_{1}}} {u}_{m} & … & {{e}^{j \frac{4 π l ( {N}_{1} / 2 - 1 )}{{O}_{1} {N}_{1}}} {u}_{m} ]}^{T}\end{matrix}\end{matrix} \qquad Equation 1$$

Optionally, in operation 402, the UE determines or reports a CSI report or reports CSI parameters based on a plurality of spatial parameters and/or power parameters associated with the CSI report configuration information (for example, report a CSI report or report a CSI report containing/associated with the CSI parameters), wherein the CSI parameters are in a first CSI report. Here, the first CSI report may be a CSI report. Optionally, the CSI report may be in a physical uplink control channel (PUCH) or in a physical uplink shared channel (PUSCH). The advantage of doing so is that, since the total number of CSI reports is limited, reporting (a set of) CSI parameters corresponding to (combinations of) a plurality of spatial parameters and/or power parameters in the same CSI report can save CSI report resources. Optionally, the plurality of spatial parameters and/or power parameters are associated with one or more reference signal resources. Here, a mapping method between the plurality of spatial parameters and/or power parameters and the one or more reference signal resources is as follows.

### Method I

The CSI report configuration information is associated with a reference signal resource (for example, a synchronous signal block (SSB) resource or a CSI-RS resource). Optionally, the maximum number of reference signal resources or reference signal resource groups that can be associated with the CSI report (configuration) is 1. Optionally, the reference signal resource is associated with one or more power parameters. Optionally, the reference signal resource is a reference signal resource for channel measurement. Optionally, the CSI report configuration information (or the reference signal resource) is associated with one or more spatial parameters. Optionally, the one or more spatial parameters are in the CSI report configuration information. Here, the UE determining or reporting CSI parameters based on a plurality of spatial parameters and/or power parameters associated with the CSI report configuration information means determining (the number of) CSI parameters based on (the number of) combinations of one or more power parameters and/or one or more spatial parameters (of reference signal resources). Optionally, (when the CSI report is associated with/contains a plurality of reference signal resources (sets)), the base station may indicate (a) specific reference signal resources (sets) (e.g., (combinations of) the spatial parameters or power parameters associated with the reference signal resources are used to determine/calculate the CSI parameters). Optionally, combinations of one or more power parameters and one or more spatial parameters may be combinations of power parameters and spatial parameters (e.g., all combinations or a subset of all combinations). Optionally, a subset of the parameters (or parameter combinations) is determined based on predefined rules, or a subset of the combination is indicated by the base station or reported by the UE. For example, if the one or more spatial parameters are {Spatial #1, spatial #2}, and the one or more power parameters are {Power #1, Power #2 and Power #3}, then (all) combinations of the power parameters and the spatial parameters are {Spatial #1, power #1}; {Spatial #1, Power #2}; {Spatial #1, Power #3}; {Spatial #2, Power #1}; {Spatial #2, Power #2} and {Spatial #2, Power #3}. Optionally, the base station may indicate a part of all combinations (by means of a bitmap or a combination list). For example, the base station configures a combination list, and each item in the list comprises an index of a combination of one or more power parameters and one or more spatial parameters. When the UE receives indication information indicating one of the items in the list from the base station, the UE determines the CSI parameters based on a combination of the indicated power parameters and spatial parameters. Optionally, the predefined rules may be that the UE determines the CSI parameters based on all of the plurality of spatial parameters or all of the plurality of power parameters or all of the combinations of the plurality of power parameters and/or spatial parameters. Optionally, the predefined rules may be that the UE determines the CSI parameters based on one of the plurality of spatial parameters (for example, the first of indication/configuration information; for another example, the one with the smallest (configuration) ID) or one of the plurality of power parameters (for example, the first of indication/configuration information; for another example, the one with the smallest (configuration) ID) or one of the combinations of the plurality of power parameters and/or spatial parameters (for example, the first of indication/configuration information; for another example, the one with the smallest (configuration) ID). Optionally, the UE may indicate (through a CSI parameter, such as CRI) a part of the plurality of spatial parameters or a part of the plurality of power parameters or a part of the combinations of the plurality of power parameters and/or spatial parameters.

The advantage of this method is that UE can calculate CSI parameters corresponding to different combinations of spatial parameters and/or power parameters by measuring a reference signal resource, which saves the reference signal measurement resources that the UE needs to use.

### Method II

The CSI report configuration information is associated with one or more reference signal resources (sets) (for example, SSB resources or CSI-RS resources). Optionally, each reference signal resource is associated with one or more power parameters. Optionally, the reference signal resource is reference signal resource for channel measurement. Optionally, each reference signal resource is associated with one or more spatial parameters. Optionally, the one or more spatial parameters are in the CSI report configuration information. Here, the UE determining or reporting CSI parameters based on a plurality of spatial parameters and/or power parameters associated with the CSI report configuration information means determining (the number of) CSI parameters based on (the number of) combinations of the one or more power parameters and/or one or more spatial parameters (associated with reference signal resources). Optionally, combinations of one or more power parameters and/or one or more spatial parameters may be combinations of power parameters and spatial parameters (e.g., all combinations or a subset of all combinations). Optionally, a subset of the parameters (or the combinations) is determined based on predefined rules, or a subset of the combination is indicated by the base station or reported by the UE. For example, for one reference signal resource, if the one or more spatial parameters are {Spatial #1, spatial #2}, and the one or more power parameters are {Power #1, Power #2 and Power #3}, then (all) combinations of the power parameters and the spatial parameters are {Spatial #1, power #1}; {Spatial #1, Power #2}; {Spatial #1, Power #3}; {Spatial #2, Power #1}; {Spatial #2, Power #2} and {Spatial #2, Power #3}. Optionally, (when the CSI report is associated with/contains a plurality of reference signal resources), the base station may indicate specific reference signal resources (e.g., the reference signal resource(s) corresponding to (combinations of) the spatial parameters or power parameters associated with are used to determine/calculate the CSI parameters). Optionally, (for a plurality of spatial parameters and/or a plurality of power parameters and/or combinations of spatial parameters and/or power parameters associated with reference signal resource(s)), the base station may indicate a part of all combinations (by means of a bitmap or a combination list). For example, the base station configures a combination list, and each item in the list comprises index(es) of combination(s) for one or more power parameters and/or one or more spatial parameters. When the UE receives indication information indicating one of the items in the list from the base station, the UE determines the CSI parameters based on the indicated combination(s) of the power parameters and spatial parameters. Optionally, the predefined rules may be that the UE determines the CSI parameters based on all of the plurality of spatial parameters or all of the plurality of power parameters or all of the combination(s) of power parameters and/or spatial parameters. Optionally, the predefined rules may be that the UE determines the CSI parameters based on one of the plurality of spatial parameters (for example, the first of indication/configuration information; for another example, the one with the smallest (configuration) ID) or one of the plurality of power parameters (for example, the first of indication/configuration information; for another example, the one with the smallest (configuration) ID) or one of the combinations of the plurality of power parameters and/or spatial parameters (for example, the first of indication/configuration information; for another example, the one with the smallest (configuration) ID). Optionally, the UE may indicate (through a CSI parameter, such as CRI) a part of the plurality of spatial parameters or a part of the plurality of power parameters or a part of the combinations of the plurality of power parameters and/or spatial parameters.

Optionally, the CSI report comprises CSI parameters associated with (all or all configured) reference signal resources. Optionally, the CSI report comprises CSI parameters associated with specific reference signal resources. Optionally, the specific reference signal resources (sets) can be predefined, such as all of a plurality of reference signal resources (sets), or one of a plurality of reference signal resources (sets) (for example, the first of the reference signal resource groups, or the first of corresponding reference signal resource group configuration information, or the one with the smallest configuration ID). Optionally, the specific reference signal resources may be reported by the UE (for example, through CSI-RS resource indicator (CRI)). Optionally, the specific reference signal resources may be indicated by the base station (for example, through downlink control information (DCI) or media access control-control element (MAC-CE) or RRC signaling).

The advantage of this method is that the UE can include, in a CSI report, CSI parameters associated with different combinations of spatial parameters and/or power parameters calculated by measuring one or more reference signal resources, thus saving the CSI report resources that the UE needs to use.

### Method III

The CSI report configuration information is associated with one or more reference signal resources (for example, SSB resources or CSI-RS resources). Optionally, each reference signal resource is associated with one or more power parameters. Optionally, each reference signal resource is associated with a spatial parameter. Optionally, the CSI report configuration information is associated with one or more spatial parameters, and the one or more spatial parameters are one-to-one mapped with one or more reference signal resources. Optionally, the one or more spatial parameters are in the CSI report configuration information. Here, the UE determining or reporting CSI parameters based on a plurality of spatial parameters and/or power parameters associated with the CSI report configuration information means determining (the number of) CSI parameters based on (the number of) combinations of the one or more power parameters (and/or one spatial parameter) (associated with reference signal resources). Optionally, combinations of one or more power parameters and one spatial parameter may be combinations of the power parameters and the spatial parameter, such as all combinations or a subset of all combinations, or all or a subset of the one or more power parameters. Optionally, a subset of the parameters (or parameter combinations) is determined based on predefined rules, or a subset of the combination is indicated by the base station or reported by the UE. For example, for one reference signal resource, if the one spatial parameter is {Spatial #1}, and the one or more power parameters are {Power #1, Power #2 and Power #3}, then (all) combinations of the power parameters and the spatial parameter are {Spatial #1, power #1}; {Spatial #1, Power #2}; {Spatial #1, Power #3}. Optionally, (when the CSI report is associated with/contains a plurality of reference signal resources), the base station may indicate specific reference signal resources (e.g., the plurality of power parameters associated with the reference signal resources are used to determine/calculate the CSI parameters). Optionally, (for a plurality of power parameters associated with one reference signal resource), the base station may indicate a part of all combinations (by means of a bitmap or a combination list). For example, the base station configures a combination list, and each item in the list comprises an index of a combination of one or more power parameters and one or more spatial parameters. When the UE receives indication information indicating one of the items in the list from the base station, the UE determines the CSI parameters based on a combination of the indicated power parameters and spatial parameters. Optionally, the predefined rules may be that the UE determines the CSI parameters based on all of the plurality of spatial parameters or all of the plurality of power parameters or all of the combinations of the plurality of power parameters and/or spatial parameters. Optionally, the predefined rules may be that the UE determines the CSI parameters based on one of the plurality of spatial parameters (for example, the first of indication/configuration information; for another example, the one with the smallest (configuration) ID) or one of the plurality of power parameters (for example, the first of indication/configuration information; for another example, the one with the smallest (configuration) ID) or one of the combinations of the plurality of power parameters and/or spatial parameters (for example, the first of indication/configuration information; for another example, the one with the smallest (configuration) ID). Optionally, the UE may indicate (through a CSI parameter, such as CRI) a part of the plurality of spatial parameters or a part of the plurality of power parameters or a part of the combinations of the plurality of power parameters and/or spatial parameters.

Optionally, the CSI report comprises CSI parameters associated with (all or all configured) reference signal resources. Optionally, the CSI report comprises CSI parameters associated with specific reference signal resources. Optionally, the specific reference signal resources (sets) can be predefined, such as all of a plurality of reference signal resources (sets), or one of a plurality of reference signal resources (sets) (for example, the first of the reference signal resource groups, or the first of corresponding reference signal resource group configuration information, or the one with the smallest configuration ID). Optionally, the specific reference signal resources may be reported by the UE (for example, through CRI). Optionally, the specific reference signal resources may be indicated by the base station (for example, through DCI or MAC-CE or RRC signaling).

The advantage of this method is that the UE can include, in a CSI report, CSI parameters associated with different spatial parameters calculated by measuring one or more reference signal resources, thus saving the CSI report resources that the UE needs to use.

### Method IV

The CSI report configuration information is associated with one or more reference signal resources (for example, SSB resources or CSI-RS resources). Optionally, each reference signal resource is associated with one power parameter. Optionally, each reference signal resource is associated with one or more spatial parameters. Here, the UE determining or reporting CSI parameters based on a plurality of spatial parameters and/or power parameters associated with the CSI report configuration information means determining (the number of) CSI parameters based on (the number of) combinations of the one or more power parameters and/or one spatial parameter (associated with reference signal resources). Optionally, combinations of one power parameter and/or one or more spatial parameters may be combinations of the power parameter and spatial parameters (e.g., all combinations or a subset of all combinations). Optionally, a subset of the parameters (or parameter combinations) is determined based on predefined rules, or a subset of the combination is indicated by the base station or reported by the UE. For example, for one reference signal resource, if the one or more spatial parameters are {Spatial #1, spatial #2, Spatial #3}, and the one power parameter is {Power #1}, then (all) combinations of the power parameter and the spatial parameters are {Spatial #1, power #1}; {Spatial #2, Power #1}; and {Spatial #3, Power #1}. Optionally, the base station may indicate a part of all combinations (by means of a bitmap or a combination list). Optionally, (when the CSI report is associated with/contains a plurality of reference signal resources), the base station may indicate specific reference signal resources (e.g., (combinations of) the spatial parameters or power parameters associated with the reference signal resources are used to determine/calculate the CSI parameters). For example, (for a plurality of spatial parameters associated with one reference signal resource), the base station configures a combination list, and each item in the list comprises an index of one or more spatial parameters. When the UE receives indication information indicating one of the items in the list from the base station, the UE determines the CSI parameters based on the indicated spatial parameters (or reference signal resources). Optionally, the predefined rules may be that the UE determines the CSI parameters based on all of the plurality of spatial parameters or all of the plurality of power parameters or all of the combinations of the plurality of power parameters and/or spatial parameters. Optionally, the predefined rules may be that the UE determines the CSI parameters based on one of the plurality of spatial parameters (for example, the first of indication/configuration information; for another example, the one with the smallest (configuration) ID) or one of the plurality of power parameters (for example, the first of indication/configuration information; for another example, the one with the smallest (configuration) ID) or one of the combinations of the plurality of power parameters and/or spatial parameters (for example, the first of indication/configuration information; for another example, the one with the smallest (configuration) ID). Optionally, the UE may indicate (through a CSI parameter, such as CRI) a part of the plurality of spatial parameters or a part of the plurality of power parameters or a part of the combinations of the plurality of power parameters and/or spatial parameters.

Optionally, the CSI report comprises CSI parameters associated with (all or all configured) reference signal resources. Optionally, the CSI report comprises CSI parameters associated with specific reference signal resources. Optionally, the specific reference signal resources (sets) can be predefined, such as all of a plurality of reference signal resources (sets), or one of a plurality of reference signal resources (sets) (for example, the first of the reference signal resource groups, or the first of corresponding reference signal resource group configuration information, or the one with the smallest configuration ID). Optionally, the specific reference signal resources may be reported by the UE (for example, through CRI). Optionally, the specific reference signal resources may be indicated by the base station (for example, through DCI or MAC-CE or RRC signaling).

The advantage of this method is that the UE can include, in a CSI report, CSI parameters associated with different power parameters calculated by measuring one or more reference signal resources, thus saving the CSI report resources that the UE needs to use.

### Method V

The CSI report configuration information is associated with one or more reference signal resources (for example, SSB resources or CSI-RS resources). Optionally, each reference signal resource is associated with one power parameter. Optionally, each reference signal resource is associated with a spatial parameter. Here, the UE determining or reporting CSI parameters based on a plurality of spatial parameters and/or power parameters associated with the CSI report configuration information means determining (the number of) CSI parameters based on (the number of) the power parameters and/or spatial parameters (associated with reference signal resources). Optionally, the reference signal resources (for determining the CSI parameters) are determined based on predefined rules or indicated by the base station or reported by the UE. For example, for a plurality of reference signal resources (for example, two), the corresponding spatial parameters and power parameters are {Spatial #1, power #1}; and {Spatial #2, Power #2}. Optionally, the base station may indicate a subset of a plurality of reference signal resources (by means of a bitmap or a combined list). When the UE receives an indication from the base station, the UE determines the CSI parameters based on the indicated reference signal resources (associated spatial parameters and power parameters).

Optionally, the CSI report comprises CSI parameters associated with (all or all configured) reference signal resources. Optionally, the CSI report comprises CSI parameters associated with specific reference signal resources. Optionally, the specific reference signal resources (sets) can be predefined, such as all of a plurality of reference signal resources (sets), or one of a plurality of reference signal resources (sets) (for example, the first of the reference signal resource groups, or the first of corresponding reference signal resource group configuration information, or the one with the smallest configuration ID). Optionally, the specific reference signal resources may be reported by the UE (for example, through CRI). Optionally, CRI is in a first CSI report. Optionally, the size of a field (bit) corresponding to the CRI is related to the number (NRS) of reference signals associated with CSI report (for example, N_{RS} is ┌log₂ N_{RS}┐). Here, the specific reference signal resources may be indicated by the base station (for example, through DCI or MAC-CE or RRC signaling). The advantage of this method is that the UE can include, in a CSI report, CSI parameters associated with different power parameters calculated by measuring one or more reference signal resources, thus saving the CSI report resources that the UE needs to use.

(Based on the above methods, such as at least one of methods from method I to V), the UE can determine which spatial parameters (which of the plurality of spatial parameters) and/or power parameters (which of the plurality of power parameters) and/or combinations of the spatial parameters and the power parameters (which of the combinations of the spatial parameters and the power parameters) the reported CSI parameters are associated with. Optionally, (further), a mapping relationship between the reported CSI parameters and the corresponding spatial parameters and/or power parameters needs to be further determined. Optionally, the mapping relationship between the CSI parameters and the spatial parameters and/or the power parameters and/or the combinations of the spatial parameters and the power parameters is predefined (for example, one-to-one mapped). Optionally, the mapping relationship between the CSI parameters and the spatial parameters and/or the power parameters and/or the combinations of the spatial parameters and the power parameters is indicated by the base station. Optionally, the mapping relationship between the CSI parameters and the spatial parameters and/or the power parameters and/or the combinations of the spatial parameters and the power parameters is reported by the UE. Optionally, the mapping relationship between the CSI parameters and the spatial parameters and/or the power parameters and/or the combinations of the spatial parameters and the power parameters is selected by the UE.

Here, by taking PMI parameter(s) as the CSI parameter(s), a method for determining the mapping relationship between (combination(s) of) power parameters and/or spatial parameters and the CSI parameters is explained. Optionally, the PMI parameters may be PMI parameters associated with the type I codebook. Optionally, the PMI parameters may be PMI parameters of the type I single-panel codebook. For example, the PMI parameters (of the type I single-panel codebook) comprise (codebook index parameters): at least one of i_{1,1}, i_{1,2}, i_{1,3} and i₂. For example, the PMI parameters may be PMI parameters of the type I multi-panel codebook. For example, the PMI parameters (of the type I multi-panel codebook) comprise (codebook index parameters): at least one of i_{1,1}, i_{1,2}, i_{1,3}, i_{1,4,1}, i_{1,4,2}, i_{1,4,3}, i₂, i_{2,0}, i_{2,1} and i_{2,2}.

Optionally, the mapping relationship between the CSI parameter(s) and (combination(s) of) power parameters and/or spatial parameters is predefined or indicated by the base station or reported by the UE. Here, (combination(s) of) power parameters and/or spatial parameters may be all combination(s) of the power parameters and/or spatial parameters (described in the above method). (Combination(s) of) power parameters and/or spatial parameters may also be a subset of combination(s) indicated by the base station, a subset reported by the UE or a predetermined subset of the combination(s) of the power parameters and/or spatial parameters (described in the above method).

Optionally, the (predefined) mapping relationship between the CSI parameters and (combination(s) of) power parameters and/or spatial parameters comprises that each of (combination of) power parameters and/or spatial parameters corresponds to/is associated with a PMI parameter. For example, each of (all) combinations of power parameters and/or spatial parameters (associated with one or more reference signal resources) is associated with a PMI parameter. For example, the power parameters and/or spatial parameters associated with a reference signal resource comprise/are associated with four parameter combinations {Spatial #1, Power #1}; {Spatial #1, Power #2}; {Spatial #2, Power #1}; {Spatial #2, Power #2}, and these four combinations correspond to PMI parameters PMI #1, PMI #2, PMI #3 and PMI #4 respectively. PMI #1 is determined/calculated based on {Spatial #1, Power #1}. PMI #2 is determined/calculated based on {Spatial #1, Power #2}. PMI #3 is determined/calculated based is on {Spatial #2, Power #1}. PMI #4 determined/calculated based on {Spatial #2, Power #2}. For another example, the power parameters and/or spatial parameters associated with two reference signal resources comprise/are associated with four parameter combinations {Spatial #1, Power #1}; {Spatial #1, Power #2}; {Spatial #2, Power #1}; {Spatial #2, Power #2}, where a first reference signal resource comprises/is associated with two parameter combinations {Spatial #1, Power #1} and {Spatial #1, Power #2}. A second reference signal resource comprises/is associated with two parameter combinations {Spatial #2, Power #1} and {Spatial #2, Power #2}. These combinations (associated with the two reference signal resources) correspond to PMI parameters PMI #1, PMI #2, PMI #3 and PMI #4, respectively. PMI #1 is determined/calculated based on {Spatial #1, Power #1} of the first reference signal resource. PMI #2 is determined/calculated based on {Spatial #1, Power #2} of the first reference signal resource. PMI #3 is determined/calculated based on {Spatial #2, Power #1} of the second reference signal resource. PMI #4 is determined/calculated based on {Spatial #2, Power #2} of the second reference signal resource. Optionally, the order of the (one or more) PMI parameters is related to at least one of the following:
the order of the reference signal resources, for example, the order of the reference signal resources in a reference signal resource group (configuration information), and for another example, the order of reference signal resource (configuration) IDs;
the order of the (one or more) spatial parameters, for example, the order of the spatial parameters in corresponding configuration information/indication information, and for another example, the order of spatial parameter (associated configuration) IDs;
the order of the (one or more) power parameters, for example, the order of the spatial parameters in corresponding configuration information/indication information, and for another example, the order of spatial parameter (associated configuration) IDs; and
the order of the (one or more) combinations of the spatial parameters and/or power parameters, for example, the order of the combinations of the spatial parameters and/or power parameters in corresponding configuration information/indication information, and for another example, the order of combination (associated configuration) IDs of spatial parameter and/or power parameter.

Optionally, the above methods for determining the order can be used simultaneously. For example, each method corresponds to a different priority. For example, the priority from high to low can be: the order of the reference signal resources>the order of the spatial parameters (if any)>the order of the power parameters. For example, the priority from high to low can be: the order of the reference signal resources>the order of the combinations of the spatial parameters and/or power parameters. For example, the order of the spatial parameters>the order of the power parameters. For example, the priority from high to low can be: the order of the reference signal resources>the order of the power parameters>the order of the spatial parameters. For example, the order of the power parameters>the order of the spatial parameters. For example, the priority from high to low can be: the order of the reference signal resources>the order of the power parameters.

Optionally, the (predefined) mapping relationship between the CSI parameters and (combinations of) power parameters and/or spatial parameters comprises that (combinations of) power parameters and/or spatial parameters correspond to/are associated with a PMI parameter. For example, (all) combinations of the plurality of power parameters and/or spatial parameters (associated with one or more reference signal resources) are associated with a first PMI parameter. Optionally, the first PMI parameter may be a set of PMI parameters shared by (all) combinations of the plurality of power parameters and/or spatial parameters (associated with one or more reference signal resources). For example, the power parameters and/or spatial parameters associated with a reference signal resource comprise/are associated with four parameter combinations {Spatial #1, Power #1}; {Spatial #1, Power #2}; {Spatial #2, Power #1}; {Spatial #2, Power #2}, and these four combinations are associated with/correspond to the PMI parameter PMI #1. Optionally, the first PMI parameter is determined based on (combinations of) (specific) spatial parameters and/or power parameters.

Optionally, (if the first PMI parameter is associated with a plurality of spatial parameters), the first PMI parameter is determined based on (a specific one, one, part or all of) the spatial parameters. Optionally, the specific one, one, part or all of the spatial parameters are reference spatial parameters. Optionally, the reference spatial parameters are spatial parameters for determining the shared first PMI parameter. Optionally, (if the first PMI parameter is associated with a plurality of spatial parameters (associated with one or more reference signal resources)), the first PMI parameter is determined based on a spatial parameter with the smallest number of ports or the largest number of ports among the plurality of spatial parameters (associated with one or more reference signal resources). Optionally, the spatial parameter with the smallest/largest number of ports among the plurality of spatial parameters may be a reference spatial parameter. Here, the number of ports can be equivalently replaced by at least one of the following: the first-dimension number, the second-dimension number, the first-dimension oversampling parameter and the second-dimension oversampling parameter. Optionally, the number of ports of the spatial parameter is 2*N₁*N₂, where N₁ is the first-dimension number and N₂ is the second-dimension number. Optionally, the number of ports of the spatial parameter is N₁, where N₁ is the first-dimension number. Optionally, the number of ports of the spatial parameter is N₂, where N₂ is the second-dimension number. For example, if the first PMI parameter is associated with Spatial #1 and Spatial #2, and the number of ports of Spatial #1 is smaller than that of Spatial #2, then the first PMI parameter is determined based on Spatial #1. Optionally, if the first PMI parameter is associated with a plurality of spatial parameters (associated with one or more reference signal resources) (if the numbers of ports associated with these spatial parameters are the same), the first PMI parameter is determined based on a spatial parameter with the smallest or largest ID (for example, configured ID) among the plurality of spatial parameters (associated with one or more reference signal resources). Optionally, if the first PMI parameter is associated with a plurality of spatial parameters (associated with one or more reference signal resources) (if the numbers of ports associated with these spatial parameters are the same), the first PMI parameter is determined based on the positions of the plurality of spatial parameters in the signaling. For example, if the first PMI parameter is associated with a plurality of spatial parameters (associated with one or more reference signal resources) (if the numbers of ports associated with these spatial parameters are the same), the first PMI parameter is determined based on a first spatial parameter among the plurality of spatial parameters (for example, a first spatial parameter in the signaling carrying the plurality of spatial parameters).

Optionally, (if the first PMI parameter is associated with a plurality of power parameters), the first PMI parameter is determined based on (a specific one, one, part or all of) the power parameters. Optionally, the specific one, one, part or all of the power parameters are reference power parameters. Optionally, (if the first PMI parameter is associated with a plurality of power parameters), the first PMI parameter is determined based on a power parameter with the smallest power value or the largest power value among the plurality of power parameters. Optionally, (if the first PMI parameter is associated with a plurality of power parameters (associated with one or more reference signal resources)), the first PMI parameter is determined based on a power parameter with the smallest or largest ID (for example, configured ID) among the plurality of power parameters. Optionally, if the first PMI parameter is associated with a plurality of power parameters (associated with one or more reference signal resources), the first PMI parameter is determined based on the positions of the plurality of power parameters in the signaling. For example, if the first PMI parameter is associated with a plurality of power parameters (associated with one or more reference signal resources), the first PMI parameter is determined based on a first power parameter among the plurality of power parameters (for example, a first power parameter in the signaling carrying the plurality of power parameters).

Optionally, (if the first PMI parameter is associated with a plurality of power parameters and/or spatial parameters), the first PMI parameter is determined based on (combinations of) (one, part or all of (combinations of) specific or a plurality of power parameters and/or spatial parameters) power parameters and/or spatial parameters. Optionally, (combinations of) one, part or all of (combinations of) specific or a plurality of power parameters and/or spatial parameters are reference parameters. Optionally, (if the first PMI parameter is associated with a plurality of power parameters and/or spatial parameters), the first PMI parameter is determined based on (combinations of) a power parameter and/or spatial parameter with the smallest or largest ID (configured ID) among (combinations of) power parameters and/or spatial parameters. Optionally, (if the first PMI parameter is associated with (combinations of) a plurality of power parameters and/or spatial parameters (associated with one or more reference signal resources), the first PMI parameter is determined based on (combinations of) a power parameter with the smallest or largest ID (for example, configured ID) among the plurality of power parameters and/or the spatial parameters. Optionally, if the first PMI parameter is associated with (combinations of) a plurality of power parameters and/or spatial parameters (associated with one or more reference signal resources), the first PMI parameter is determined based on the positions of (combinations of) power parameters and/or spatial parameters in the signaling. For example, if the first PMI parameter is associated with (combinations of) a plurality of power parameters and/or spatial parameters (of one or more reference signal resources), the first PMI parameter is determined based on a first power parameter or spatial parameter among the plurality of power parameters (for example, (combinations of) a first power parameter or spatial parameter in the signaling carrying (combinations of) power parameters and/or spatial parameters).

The advantage of this scheme is that different spatial parameters and/or power parameters can share the same CSI parameters, which saves the overhead of CSI report. In addition, this scheme can determine a reference parameter (for calculating the CSI parameters) (e.g., reference spatial parameter, reference power parameter) when there are a plurality of power parameters and/or spatial parameters (i.e., there are a plurality of combinations of power parameters and/or spatial parameters), so as to reduce the complexity of CSI calculation for the UE (e.g., it is not necessary to calculate the CSI parameters based on the plurality of power parameters and/or spatial parameters, but only based on one power parameter and/or spatial parameter).

When a plurality of spatial parameters correspond to the same PMI parameter (first PMI parameter), one of the plurality of spatial parameters (for example, a spatial parameter other than the reference spatial parameter; for example, referred to as a first spatial parameter) determines precoding parameters (or PMI parameters or codebook index parameters) based on the reference spatial parameter (or a spatial parameter associated with the reference parameter). For example, one of the plurality of spatial parameters is the same as the reference spatial parameter.

For example, when the first-dimension number (N₁) of the reference spatial parameter is the same as the first-dimension number (N₁) associated with the first spatial parameter, i_{1,1} associated with the reference spatial parameter is equal to i_{1,1} associated with the first spatial parameter. For example, when the first-dimension number (N₁) of the reference spatial parameter is different from the first-dimension number (N₁) associated with the first spatial parameter (and N₁ of the reference spatial parameter is smaller than N₁ associated with the first spatial parameter), i_{1,1} associated with the first spatial parameter is determined based on i_{1,1} associated with the reference spatial parameter. For example, the ratio of i_{1,1} associated with the first spatial parameter to i_{1,1} associated with the reference spatial parameter is equal to or based on \hat{p}. Here, \hat{p} refers to the ratio of N₁ of the first spatial parameter to N₁ associated with the reference spatial parameter. i_{1,1} associated with the first spatial parameter is equal to the product of i_{1,1} associated with the reference spatial parameter and \hat{p}.

For example, when the second-dimension number (N₂) of the reference spatial parameter is the same as the second-dimension number (N₂) associated with the first spatial parameter, i_{1,2} associated with the reference spatial parameter is equal to i_{1,2} associated with the first spatial parameter. For example, when the second-dimension number (N₂) of the reference spatial parameter is different from the second-dimension number (N₂) associated with the first spatial parameter (and N₂ of the reference spatial parameter is smaller than N₂ associated with the first spatial parameter), i_{1,2} associated with the first spatial parameter is determined based on i_{1,2} associated with the reference spatial parameter. For example, the ratio of i_{1,2} associated with the first spatial parameter to i_{1,2} associated with the reference spatial parameter is equal to or based on \hat{q}. Here, \hat{q} refers to the ratio of N₂ of the first spatial parameter to N₂ associated with the reference spatial parameter. i_{1,2} associated with the first spatial parameter is equal to the product of i_{1,2} associated with the reference spatial parameter and \hat{q}. Optionally, this method is suitable for the determination of broadband PMI parameters and/or for the determination of subband PMI parameters (for example, PMI parameters of each subband).

The advantage of this scheme is that the base station can obtain the precoding parameters corresponding to each spatial parameter based on the common (shared) PMI parameters of a plurality of spatial parameters reported by the UE, thus helping the base station use these parameters for more accurate scheduling.

Optionally, the mapping relationship (indicated by the base station) between the CSI parameter(s) and (combination(s) of) power parameters and/or spatial parameters comprises that each of the (combination(s) of) power parameters and/or spatial parameters indicated by the base station among (combination(s) of) power parameters and/or spatial parameters corresponds to/is associated with a PMI parameter. It can be understood that the base station here indicates a subset of power parameters or the plurality of spatial parameters or combination(s) of the plurality of spatial parameters and power parameters related to the CSI parameters. Here, for a method of mapping/association between (the subset of) the plurality of power parameters and/or spatial parameters (indicated by the base station) and the PMI parameter, please refer to the description of the predefined mapping relationship. Optionally, the base station may perform the indication via at least one of RRC, MAC-CE or DCI.

Optionally, the mapping relationship (indicated by the base station) between the CSI parameters and (combinations of) power parameters and/or spatial parameters comprises that the (combinations of) power parameters and/or spatial parameters indicated by the base station among (combinations of) power parameters and/or spatial parameters correspond to/are associated with a PMI parameter (for example, a first PMI parameter). It can be understood that the base station here indicates a subset of the plurality of power parameters or the plurality of spatial parameters or combinations of the plurality of spatial parameters and power parameters related to the CSI parameters. Here, for a method of mapping/association between the plurality of power parameters and/or spatial parameters (indicated by the base station) and the PMI parameter, please refer to the description of the predefined mapping relationship. Optionally, the base station may perform indication through at least one of RRC, MAC-CE or DCI.

Using the above method, the base station can signal, based on the correlation level of parameters (e.g., the difference between indexes of PMI parameters, the Euclidean distance of spatial vectors corresponding to PMI parameters, the value of CQI or measured L1-RSRP corresponding to PMI parameters), to separately report associated CSI parameters for a part of (combinations of) power parameters and/or spatial parameters, and report their associated (common or shared) CSI parameters in a single CSI report for another part of (combinations of) power parameters and/or spatial parameters, thus reducing the overhead of CSI report.

Optionally, the mapping relationship (reported by the UE/selected by the UE) between the CSI parameters and (combinations of) power parameters and/or spatial parameters comprises that each of (combinations of) power parameters and/or spatial parameters associated with a second indicator (or second information) among (combinations of) power parameters and/or spatial parameters corresponds to/is associated with a PMI parameter. Optionally, the CSI parameters comprise a second indicator (or second information). The UE reports the second indicator (or second information) to the base station. Optionally, the second indicator (or second information) is in the first CSI report. Here, for a method of mapping/association between the plurality of power parameters and/or spatial parameters and the PMI parameter, please refer to the description of the predefined mapping relationship. Optionally, among the plurality of power parameters and/or spatial parameters associated with the CSI parameters, for (combinations of) power parameters and/or spatial parameters not reported, the UE does not report CSI parameters corresponding to the (combinations of) power parameters and/or spatial parameters. Optionally, among the plurality of power parameters and/or spatial parameters associated with the CSI parameters, (combinations of) power parameters and/or spatial parameters not reported are associated with/correspond to/share one PMI parameter (for example, the first PMI parameter). For a method of mapping/association between the plurality of power parameters and/or spatial parameters and the PMI parameter, please refer to the description of the predefined mapping relationship.

Optionally, the mapping relationship between the CSI parameters and (combinations of) power parameters and/or spatial parameters (reported by the UE or associated with the second indicator or second information) comprises that (combinations of) power parameters and/or spatial parameters associated with the second indicator (or second information) among (combinations of) power parameters and/or spatial parameters correspond to/are associated with a PMI parameter. For example, the (combinations of) power parameters and/or spatial parameters associated with the second indicator share/correspond to the first PMI parameter. Optionally, the CSI parameters comprise a second indicator (or second information). The UE reports the second indicator (or second information) to the base station. Optionally, the second indicator (or second information) is in the first CSI report. Optionally, the second indicator (or second information) may be associated with the CRI. Here, for a method of mapping/association between the plurality of power parameters and/or spatial parameters and the PMI parameter, please refer to the description of the predefined mapping relationship. Optionally, among the plurality of power parameters and/or spatial parameters associated with the CSI parameters, for (combinations of) power parameters and/or spatial parameters not reported, the UE does not report CSI parameters corresponding to the (combinations of) power parameters and/or spatial parameters. Optionally, among the plurality of power parameters and/or spatial parameters associated with the CSI parameters, (combinations of) power parameters and/or spatial parameters not reported each correspond to/are each associated with a PMI parameter. For a method of mapping/association between the plurality of power parameters and/or spatial parameters and the PMI parameter, please refer to the description of the predefined mapping relationship.

Using the above method, the UE can, based on the correlation level of parameters (e.g., the difference between indexes of PMI parameters, the Euclidean distance of spatial vectors corresponding to PMI parameters, the value of CQI or measured L1-RSRP corresponding to PMI parameters), separately report associated CSI parameters for a part of (combinations of) power parameters and/or spatial parameters, and report their associated (common or shared) CSI parameters in a single CSI report for another part of (combinations of) power parameters and/or spatial parameters, thus reducing the overhead of CSI report.

Optionally, the first PMI parameter (set) (for example, described in the above method) comprises at least one of (codebook index parameters) i_{1,1}, i_{1,2}, i_{1.3} and i₂. Optionally, the first PMI parameter comprises (codebook index parameters): at least one of i_{1,1}, i_{1,2}, i_{1,3}, i_{1,4,1}, i_{1,4,2}, i_{1,4,3}, i₂, i_{2,0}, i_{2,1} and i_{2,2}. Here, those parameters included in the first PMI parameter can be determined by at least one of the following methods.

### Method I

The parameters included in the first PMI parameter are predefined. For example, the first PMI parameter comprises parameters i_{1,1} and i_{1,2}. For example, the mapping relationship between the CSI parameters and (combinations of) power parameters and/or spatial parameters comprises that (combinations of) power parameters and/or spatial parameters indicated by the base station among (combinations of) power parameters and/or spatial parameters correspond to/are associated with an i_{1,1} and an i_{1,2}. By this method, the UE can report the CSI parameters specified by a common protocol based on (combinations of) power parameters and/or spatial parameters, thereby reducing the overhead of CSI report.

### Method II

The parameters included in the first PMI parameter are indicated by the base station. For example, the first PMI parameter indicated by the base station comprises parameters i_{1,1} and i_{1,2}. For example, the mapping relationship between the CSI parameters and (combinations of) power parameters and/or spatial parameters comprises that (combinations of) power parameters and/or spatial parameters indicated by the base station among (combinations of) power parameters and/or spatial parameters correspond to/are associated with the PMI parameters indicated by the base station i_{1,1} and i_{1,2}. Optionally, the base station may perform indication through at least one of RRC, MAC-CE or DCI. By this method, the UE can report the common CSI parameters indicated by the base station based on (combinations of) power parameters and/or spatial parameters, thereby reducing the overhead of CSI report.

### Method III

The parameters included in the first PMI parameter are reported/selected by the UE (and associated with a third indicator or third information). For example, the first PMI parameter associated with the third indicator (or the third information) comprises parameters i_{1,1} and i_{1,2}. Optionally, the CSI parameters comprise the third indicator (or third information). The UE reports the third indicator (or third information) to the base station. Optionally, the third indicator (or third information) is in the first CSI report. Optionally, the third indicator (or third information) may be associated with the CRI. By this method, the UE can report the common CSI parameters selected by the UE based on (combinations of) power parameters and/or spatial parameters, thereby reducing the overhead of CSI report.

Optionally, in the above method, a plurality of power parameters and/or spatial parameters associated with CSI report (or CSI parameters) may respectively correspond to/be associated with PMI parameters not included in the first PMI parameter (for example, PMI parameters other than i_{1,1} and i_{1,2}). For a method of mapping/association between the plurality of power parameters and/or spatial parameters and the PMI parameter, please refer to the description of the predefined mapping relationship.

Optionally, the calculation/determination of the above PMI parameter(s) is based on RI(s) associated with (combination(s) of) the associated/corresponding power parameters and/or spatial parameters and/or reference signal resource(s) associated with the associated/corresponding power parameters and/or spatial parameters (for example, the reference signal resource(s) indicated by/associated with the CRI).

Here, by taking RI parameters as the CSI parameters, a method for determining the mapping relationship between (combinations of) a plurality of power parameters and/or spatial parameters and the CSI parameters is explained. Optionally, the maximum rank restriction associated with the RI parameter may be at least one of 2 or 4 or 8. This restriction has the advantages of reducing the number of candidate subsets for the UE to calculate the CSI parameters, reducing the computational complexity, and making it easier for different power parameters and/or spatial parameters to be merged for reporting.

Optionally, the mapping relationship between the CSI parameters and (combinations of) power parameters and/or spatial parameters is predefined or indicated by the base station or reported by the UE. Here, (combinations of) power parameters and/or spatial parameters may be all combinations of the power parameters and/or spatial parameters (described in the above method). (combinations of) power parameters and/or spatial parameters may also be a subset indicated by the base station, a subset reported by the UE or a predetermined subset of the combinations of the power parameters and/or spatial parameters (described in the above method).

Optionally, the (predefined) mapping relationship between the CSI parameters and (combinations of) power parameters and/or spatial parameters comprises that each of (combinations of) power parameters and/or spatial parameters corresponds to/is associated with a RI parameter. For example, each of (all) combinations of the plurality of power parameters and/or spatial parameters (associated with one or more reference signal resources) is associated with a RI parameter. For example, the power parameters and/or spatial parameters associated with a reference signal resource comprise/are associated with four parameter combinations {Spatial #1, Power #1}; {Spatial #1, Power #2}; {Spatial #2, Power #1}; {Spatial #2, Power #2}, and these four combinations correspond to RI parameters RI #1, RI #2, RI #3 and RI #4 respectively. RI #1 is determined/calculated based on {Spatial #1, Power #1}. RI #2 is determined/calculated based on {Spatial #1, Power #2}. RI #3 is determined/calculated based on {Spatial #2, Power #1}. RI #4 is determined/calculated based on {Spatial #2, Power #2}. For another example, the power parameters and/or spatial parameters associated with two reference signal resources comprise/are associated with four parameter combinations {Spatial #1, Power #1}; {Spatial #1, Power #2}; {Spatial #2, Power #1}; {Spatial #2, Power #2}, where a first reference signal resource comprises/is associated with two parameter combinations {Spatial #1, Power #1} and {Spatial #1, Power #2}. A second reference signal resource comprises/is associated with two parameter combinations {Spatial #2, Power #1} and {Spatial #2, Power #2}. These combinations (associated with the two reference signal resources) correspond to RI parameters RI #1, RI #2, RI #3 and RI #4 respectively. RI #1 is determined/calculated based on {Spatial #1, Power #1} of the first reference signal resource. RI #2 is determined/calculated based on {Spatial #1, Power #2} of the first reference signal resource. RI #3 is determined/calculated based on {Spatial #2, Power #1} of the second reference signal resource. RI #4 is determined/calculated based on {Spatial #2, Power #2} of the second reference signal resource. Optionally, the order of the (one or more) RI parameters is related to at least one of the following:
the order of the reference signal resources, for example, the order of the reference signal resources in a reference signal resource group (configuration information), and for another example, the order of reference signal resource (configuration) IDs;
the order of the (one or more) spatial parameters, for example, the order of the spatial parameters in corresponding configuration information/indication information, and for another example, the order of spatial parameter (associated configuration) IDs; and
the order of the (one or more) power parameters, for example, the order of the spatial parameters in corresponding configuration information/indication information, and for another example, the order of spatial parameter (associated configuration) IDs; and
the order of the (one or more) combinations of the spatial parameters and/or power parameters, for example, the order of the combinations of the spatial parameters and/or power parameters in corresponding configuration information/indication information, and for another example, the order of combination (associated configuration) IDs of spatial parameter and/or power parameter.

Optionally, the above methods for determining the order can be used simultaneously. For example, each method corresponds to a different priority. For example, the priority from high to low can be: the order of the reference signal resources>the order of the spatial parameters (if any)>the order of the power parameters. For example, the priority from high to low can be: the order of the reference signal resources>the order of the combinations of the spatial parameters and/or power parameters. For example, the order of the spatial parameters>the order of the power parameters. For example, the priority from high to low can be: the order of the reference signal resources>the order of the power parameters>the order of the spatial parameters. For example, the order of the power parameters>the order of the spatial parameters. For example, the priority from high to low can be: the order of the reference signal resources>the order of the power parameters.

Optionally, the (predefined) mapping relationship between the CSI parameters and (combinations of) power parameters and/or spatial parameters comprises that (combinations of) power parameters and/or spatial parameters correspond to/are associated with a RI parameter. For example, (all) combinations of the plurality of power parameters and/or spatial parameters (associated with one or more reference signal resources) are associated with a first RI parameter. For example, the power parameters and/or spatial parameters associated with a reference signal resource comprise/are associated with four parameter combinations {Spatial #1, Power #1}; {Spatial #1, Power #2}; {Spatial #2, Power #1}; {Spatial #2, Power #2}, and these four combinations are associated with/correspond to the RI parameter RI #1. Optionally, the first RI parameter is determined based on (specific) spatial parameters and/or power parameters.

Optionally, (if the first RI parameter is associated with a plurality of spatial parameters), the first RI parameter is determined based on (a specific one, one, part or all of) the spatial parameters. Optionally, the specific one, one, part or all of the spatial parameters are reference spatial parameters. Optionally, (if the first RI parameter is associated with a plurality of spatial parameters (associated with one or more reference signal resources)), the first RI parameter is determined based on a spatial parameter with the smallest number of ports or the largest number of ports among the plurality of spatial parameters (associated with one or more reference signal resources). Optionally, the spatial parameter with the smallest/largest number of ports among the plurality of spatial parameters may be a reference spatial parameter. Here, the number of ports can be equivalently replaced by at least one of the following: the first-dimension number, the second-dimension number, the first-dimension oversampling parameter and the second-dimension oversampling parameter. Optionally, the number of ports of the spatial parameter is 2*N₁*N₂, where N₁ is the first-dimension number and N₂ is the second-dimension number. Optionally, the number of ports of the spatial parameter is N₁, where N₁ is the first-dimension number. Optionally, the number of ports of the spatial parameter is N₂, where N₂ is the second-dimension number. For example, if the first RI parameter is associated with Spatial #1 and Spatial #2, and the number of ports of Spatial #1 is smaller than that of Spatial #2, then the first RI parameter is determined based on Spatial #1. Optionally, if the first RI parameter is associated with a plurality of spatial parameters (associated with one or more reference signal resources) (if the numbers of ports associated with these spatial parameters are the same), the first RI parameter is determined based on a spatial parameter with the smallest or largest ID (for example, configured ID) among the plurality of spatial parameters (associated with one or more reference signal resources). Optionally, if the first RI parameter is associated with a plurality of spatial parameters (associated with one or more reference signal resources) (if the numbers of ports associated with these spatial parameters are the same), the first RI parameter is determined based on the positions of the plurality of spatial parameters in the signaling. For example, if the first RI parameter is associated with a plurality of spatial parameters (associated with one or more reference signal resources) (if the numbers of ports associated with these spatial parameters are the same), the first RI parameter is determined based on a first spatial parameter among the plurality of spatial parameters (for example, a first spatial parameter in the signaling carrying the plurality of spatial parameters).

Optionally, (if the first RI parameter is associated with a plurality of power parameters), the first RI parameter is determined based on (a specific one, one, part or all of) the power parameters. Optionally, the specific one, one, part or all of the power parameters are reference power parameters. Optionally, (if the first RI parameter is associated with a plurality of power parameters), the first RI parameter is determined based on a power parameter with the smallest power value or the largest power value among the plurality of power parameters. Optionally, (if the first RI parameter is associated with a plurality of power parameters (associated with one or more reference signal resources)), the first RI parameter is determined based on a power parameter with the smallest or largest ID (for example, configured ID) among the plurality of power parameters. Optionally, if the first RI parameter is associated with a plurality of power parameters (associated with one or more reference signal resources), the first RI parameter is determined based on the positions of the plurality of power parameters in the signaling. For example, if the first RI parameter is associated with a plurality of power parameters (associated with one or more reference signal resources), the first RI parameter is determined based on a first power parameter among the plurality of power parameters (for example, a first power parameter in the signaling carrying the plurality of power parameters).

Optionally, (if the first RI parameter is associated with a plurality of power parameters and/or spatial parameters), the first RI parameter is determined based on (combinations of) (one, part or all of (combinations of) specific or a plurality of power parameters and/or spatial parameters) power parameters and/or spatial parameters. Optionally, (combinations of) one, part or all of (combinations of) specific or a plurality of power parameters and/or spatial parameters are reference parameters. Optionally, (if the first RI parameter is associated with a plurality of power parameters and/or spatial parameters), the first RI parameter is determined based on (combinations of) a power parameter and/or spatial parameter with the smallest or largest ID (configured ID) among (combinations of) power parameters and/or spatial parameters. Optionally, (if the first RI parameter is associated with (combinations of) a plurality of power parameters and/or spatial parameters (associated with one or more reference signal resources), the first RI parameter is determined based on (combinations of) a power parameter with the smallest or largest ID (for example, configured ID) among the plurality of power parameters and/or the spatial parameters. Optionally, if the first RI parameter is associated with (combinations of) a plurality of power parameters and/or spatial parameters (associated with one or more reference signal resources), the first RI parameter is determined based on the positions of (combinations of) power parameters and/or spatial parameters in the signaling. For example, if the first RI parameter is associated with (combinations of) a plurality of power parameters and/or spatial parameters (associated with one or more reference signal resources), the first RI parameter is determined based on a first power parameter or spatial parameter among the plurality of power parameters (for example, (combinations of) a first power parameter or spatial parameter in the signaling carrying (combinations of) power parameters and/or spatial parameters).

The advantage of this scheme is that different spatial parameters and/or power parameters can share the same CSI parameters, which saves the overhead of CSI report. In addition, this scheme can determine a reference parameter (for calculating the CSI parameters) when there are a plurality of power parameters and/or spatial parameters, so as to reduce the complexity of CSI calculation for the UE (e.g., it is not necessary to calculate the CSI parameters based on the plurality of power parameters and/or spatial parameters, but only based on one power parameter and/or spatial parameter).

When a plurality of spatial parameters correspond to the same RI parameter (first RI parameter), one of the plurality of spatial parameters (for example, a spatial parameter other than the reference spatial parameter; for example, referred to as a first spatial parameter) determines RI parameters based on the reference spatial parameter (or a spatial parameter associated with the reference parameter). For example, an RI associated with the first spatial parameter is equal to an RI associated with the reference spatial parameter.

The advantage of this scheme is that the base station can obtain the RI parameters corresponding to each spatial parameter based on the common RI parameters of a plurality of spatial parameters reported by the UE, thus helping the base station use these parameters for more accurate scheduling.

Optionally, the mapping relationship (indicated by the base station) between the CSI parameters and (combinations of) power parameters and/or spatial parameters comprises that each of the (combinations of) power parameters and/or spatial parameters indicated by the base station among (combinations of) power parameters and/or spatial parameters corresponds to/is associated with a RI parameter. Here, for a method of mapping/association between the plurality of power parameters and/or spatial parameters and the RI parameter, please refer to the description of the predefined mapping relationship. Optionally, the base station may perform indication through at least one of RRC, MAC-CE or DCI.

Optionally, the mapping relationship (indicated by the base station) between the CSI parameters and (combinations of) power parameters and/or spatial parameters comprises that the (combinations of) power parameters and/or spatial parameters indicated by the base station among (combinations of) power parameters and/or spatial parameters correspond to/are associated with an RI parameter. It can be understood that the base station here indicates a subset of the plurality of power parameters or the plurality of spatial parameters or combinations of the plurality of spatial parameters and power parameters related to the CSI parameters. Here, for a method of mapping/association between (the subset of) the plurality of power parameters and/or spatial parameters (indicated by the base station) and the RI parameter, please refer to the description of the predefined mapping relationship. Optionally, the base station may perform indication through at least one of RRC, MAC-CE or DCI.

Using the above method, the base station can signal, based on the correlation level of parameters (e.g., whether the indexes of RI parameters are the same, whether the ranks of RI parameters are the same, the value of CQI or measured L1-RSRP corresponding to RI parameters), to separately report associated CSI parameters for a part of (combinations of) power parameters and/or spatial parameters, and report their associated (common or shared) CSI parameters in a single CSI report for another part of (combinations of) power parameters and/or spatial parameters, thus reducing the overhead of CSI report.

Optionally, the mapping relationship (reported/selected by the UE) between the CSI parameters and (combinations of) power parameters and/or spatial parameters comprises that each of (combinations of) power parameters and/or spatial parameters associated with a second indicator (or second information) among (combinations of) power parameters and/or spatial parameters corresponds to/is associated with an RI parameter (for example, a first RI parameter). It can be understood that the base station here indicates a subset of the plurality of power parameters or the plurality of spatial parameters or combinations of the plurality of spatial parameters and power parameters related to the CSI parameters. Optionally, the CSI parameters comprise a second indicator (or second information). The UE reports the second indicator (or second information) to the base station. Optionally, the second indicator (or second information) is in the first CSI report. Here, for a method of mapping/association between the plurality of power parameters and/or spatial parameters (indicated by the base station) and the RI parameter, please refer to the description of the predefined mapping relationship.

Optionally, the mapping relationship between the CSI parameters and (combinations of) power parameters and/or spatial parameters (reported by the UE or associated with the second indicator or second information) comprises that (combinations of) power parameters and/or spatial parameters associated with the second indicator (or second information) among (combinations of) power parameters and/or spatial parameters correspond to/are associated with a RI parameter. Optionally, the CSI parameters comprise a second indicator (or second information). The UE reports the second indicator (or second information) to the base station. Optionally, the second indicator (or second information) is in the first CSI report. Optionally, the second indicator (or second information) may be associated with the CRI. Here, for a method of mapping/association between the plurality of power parameters and/or spatial parameters and the RI parameter, please refer to the description of the predefined mapping relationship.

Using the above method, the UE can, based on the correlation level of parameters (e.g., whether the indexes of RI parameters are the same, whether the ranks of RI parameters are the same, the value of CQI or measured L1-RSRP corresponding to RI parameters), separately report associated CSI parameters for a part of (combinations of) power parameters and/or spatial parameters, and report their associated CSI parameters in a single CSI report for another part of (combinations of) power parameters and/or spatial parameters, thus reducing the overhead of CSI report.

Optionally, the calculation/determination of the above RI parameters is based on the associated/corresponding (power parameter and/or spatial parameter (combination) associated) reference signal resources (for example, CRI indicated/associated reference signal resources).

Here, by taking CQI parameters as the CSI parameters, a method for determining the mapping relationship between (combinations of) a plurality of power parameters and/or spatial parameters and the CSI parameters is explained. Optionally, the CQI parameters may be wideband CQI parameters. Optionally, the CQI parameters may be subband CQI parameters. For example, the CQI parameters comprise at least one of a wideband CQI parameter and one or more subband CQI parameters. For example, the CQI parameters comprise CQI parameters of a first codeword and CQI parameters of a second codeword.

Optionally, the mapping relationship between the CSI parameters and (combinations of) power parameters and/or spatial parameters is predefined or indicated by the base station or reported by the UE. Here, (combinations of) power parameters and/or spatial parameters may be all combinations of the power parameters and/or spatial parameters (described in the above method). (combinations of) power parameters and/or spatial parameters may also be a subset indicated by the base station, a subset reported by the UE or a predetermined subset of the combinations of the power parameters and/or spatial parameters (described in the above method).

Optionally, the (predefined) mapping relationship between the CSI parameters and (combinations of) power parameters and/or spatial parameters comprises that each of (combinations of) power parameters and/or spatial parameters corresponds to/is associated with a CQI parameter. For example, each of (all) combinations of the plurality of power parameters and/or spatial parameters (associated with one or more reference signal resources) is associated with a CQI parameter. For example, the power parameters and/or spatial parameters associated with a reference signal resource comprise/are associated with four parameter combinations {Spatial #1, Power #1}; {Spatial #1, Power #2}; {Spatial #2, Power #1}; {Spatial #2, Power #2}, and these four combinations correspond to CQI parameters CQI #1, CQI #2, CQI #3 and CQI #4 respectively. CQI #1 is determined/calculated based on {Spatial #1, Power #1}. CQI #2 is determined/calculated based on {Spatial #1, Power #2}. CQI #3 is determined/calculated based on {Spatial #2, Power #1}. CQI #4 is determined/calculated based on {Spatial #2, Power #2}. For another example, the power parameters and/or spatial parameters associated with two reference signal resources comprise/are associated with four parameter combinations {Spatial #1, Power #1}; {Spatial #1, Power #2}; {Spatial #2, Power #1}; {Spatial #2, Power #2}, where a first reference signal resource comprises/is associated with two parameter combinations {Spatial #1, Power #1} and {Spatial #1, Power #2}. A second reference signal resource comprises/is associated with two parameter combinations {Spatial #2, Power #1} and {Spatial #2, Power #2}. These combinations (associated with the two reference signal resources) correspond to CQI parameters CQI #1, CQI #2, CQI #3 and CQI #4 respectively. CQI #1 is determined/calculated based on {Spatial #1, Power #1} of the first reference signal resource. CQI #2 is determined/calculated based on {Spatial #1, Power #2} of the first reference signal resource. CQI #3 is determined/calculated based on {Spatial #2, Power #1} of the second reference signal resource. CQI #4 is determined/calculated based on {Spatial #2, Power #2} of the second reference signal resource. Optionally, the order of the (one or more) CQI parameters is related to at least one of the following:
the order of the reference signal resources, for example, the order of the reference signal resources in a reference signal resource group (configuration information), and for another example, the order of reference signal resource (configuration) IDs;
the order of the (one or more) spatial parameters, for example, the order of the spatial parameters in corresponding configuration information/indication information, and for another example, the order of spatial parameter (associated configuration) IDs; and
the order of the (one or more) power parameters, for example, the order of the spatial parameters in corresponding configuration information/indication information, and for another example, the order of spatial parameter (associated configuration) IDs; and
the order of the (one or more) combinations of the spatial parameters and/or power parameters, for example, the order of the combinations of the spatial parameters and/or power parameters in corresponding configuration information/indication information, and for another example, the order of combination (associated configuration) IDs of spatial parameter and/or power parameter.

Optionally, the above methods for determining the order can be used simultaneously. For example, each method corresponds to a different priority. For example, the priority from high to low can be: the order of the reference signal resources>the order of the spatial parameters (if any)>the order of the power parameters. For example, the priority from high to low can be: the order of the reference signal resources>the order of the combinations of the spatial parameters and/or power parameters. For example, the order of the spatial parameters>the order of the power parameters. For example, the priority from high to low can be: the order of the reference signal resources>the order of the power parameters>the order of the spatial parameters. For example, the order of the power parameters>the order of the spatial parameters. For example, the priority from high to low can be: the order of the reference signal resources>the order of the power parameters.

Optionally, the (predefined) mapping relationship between the CSI parameters and (combinations of) power parameters and/or spatial parameters comprises that (combinations of) power parameters and/or spatial parameters correspond to/are associated with a CQI parameter. For example, (all) combinations of the plurality of power parameters and/or spatial parameters (associated with one or more reference signal resources) are associated with a first CQI parameter. For example, the power parameters and/or spatial parameters associated with a reference signal resource comprise/are associated with four parameter combinations {Spatial #1, Power #1}; {Spatial #1, Power #2}; {Spatial #2, Power #1}; {Spatial #2, Power #2}, and these four combinations are associated with/correspond to the CQI parameter CQI #1. Optionally, the first CQI parameter is determined based on (specific) spatial parameters and/or power parameters.

Optionally, (if the first CQI parameter is associated with a plurality of spatial parameters), the first CQI parameter is determined based on (a specific one, one, part or all of) the spatial parameters. Optionally, the specific one, one, part or all of the spatial parameters are reference spatial parameters. Optionally, (if the first CQI parameter is associated with a plurality of spatial parameters (associated with one or more reference signal resources)), the first CQI parameter is determined based on a spatial parameter with the smallest number of ports or the largest number of ports among the plurality of spatial parameters (associated with one or more reference signal resources). Optionally, the spatial parameter with the smallest/largest number of ports among the plurality of spatial parameters may be a reference spatial parameter. Here, the number of ports can be equivalently replaced by at least one of the following: the first-dimension number, the second-dimension number, the first-dimension oversampling parameter and the second-dimension oversampling parameter. Optionally, the number of ports of the spatial parameter is 2*N₁*N₂, where N₁ is the first-dimension number and N₂ is the second-dimension number. Optionally, the number of ports of the spatial parameter is N₁, where N₁ is the first-dimension number. Optionally, the number of ports of the spatial parameter is N₂, where N₂ is the second-dimension number. For example, if the first CQI parameter is associated with Spatial #1 and Spatial #2, and the number of ports of Spatial #1 is smaller than that of Spatial #2, then the first CQI parameter is determined based on Spatial #1. Optionally, if the first CQI parameter is associated with a plurality of spatial parameters (associated with one or more reference signal resources) (if the numbers of ports associated with these spatial parameters are the same), the first CQI parameter is determined based on a spatial parameter with the smallest or largest ID (for example, configured ID) among the plurality of spatial parameters (associated with one or more reference signal resources). Optionally, if the first CQI parameter is associated with a plurality of spatial parameters (associated with one or more reference signal resources) (if the numbers of ports associated with these spatial parameters are the same), the first CQI parameter is determined based on the positions of the plurality of spatial parameters in the signaling. For example, if the first CQI parameter is associated with a plurality of spatial parameters (associated with one or more reference signal resources) (if the numbers of ports associated with these spatial parameters are the same), the first CQI parameter is determined based on a first spatial parameter among the plurality of spatial parameters (for example, a first spatial parameter in the signaling carrying the plurality of spatial parameters).

Optionally, (if the first CQI parameter is associated with a plurality of power parameters), the first CQI parameter is determined based on (a specific one, one, part or all of) the power parameters. Optionally, the specific one, one, part or all of the power parameters are reference power parameters. Optionally, (if the first CQI parameter is associated with a plurality of power parameters), the first CQI parameter is determined based on a power parameter with the smallest power value or the largest power value among the plurality of power parameters. Optionally, (if the first CQI parameter is associated with a plurality of power parameters (associated with one or more reference signal resources)), the first CQI parameter is determined based on a power parameter with the smallest or largest ID (for example, configured ID) among the plurality of power parameters. Optionally, if the first CQI parameter is associated with a plurality of power parameters (associated with one or more reference signal resources), the first CQI parameter is determined based on the positions of the plurality of power parameters in the signaling. For example, if the first CQI parameter is associated with a plurality of power parameters (associated with one or more reference signal resources), the first CQI parameter is determined based on a first power parameter among the plurality of power parameters (for example, a first power parameter in the signaling carrying the plurality of power parameters).

Optionally, (if the first CQI parameter is associated with a plurality of power parameters and/or spatial parameters), the first CQI parameter is determined based on (combinations of) (one, part or all of (combinations of) specific or a plurality of power parameters and/or spatial parameters) power parameters and/or spatial parameters. Optionally, (combinations of) one, part or all of (combinations of) specific or a plurality of power parameters and/or spatial parameters are reference parameters. Optionally, (if the first CQI parameter is associated with a plurality of power parameters and/or spatial parameters), the first CQI parameter is determined based on (combinations of) a power parameter and/or spatial parameter with the smallest or largest ID (configured ID) among (combinations of) power parameters and/or spatial parameters. Optionally, (if the first CQI parameter is associated with (combinations of) a plurality of power parameters and/or spatial parameters (associated with one or more reference signal resources), the first CQI parameter is determined based on (combinations of) a power parameter with the smallest or largest ID (for example, configured ID) among the plurality of power parameters and/or the spatial parameters. Optionally, if the first CQI parameter is associated with (combinations of) a plurality of power parameters and/or spatial parameters (associated with one or more reference signal resources), the first CQI parameter is determined based on the positions of (combinations of) power parameters and/or spatial parameters in the signaling. For example, if the first CQI parameter is associated with (combinations of) a plurality of power parameters and/or spatial parameters (associated with one or more reference signal resources), the first CQI parameter is determined based on a first power parameter or spatial parameter among the plurality of power parameters (for example, (combinations of) a first power parameter or spatial parameter in the signaling carrying (combinations of) power parameters and/or spatial parameters).

The advantage of this scheme is that different spatial parameters and/or power parameters can share the same CSI parameters, which saves the overhead of CSI report. In addition, this scheme can determine a reference parameter (for calculating the CSI parameters) when there are a plurality of power parameters and/or spatial parameters, so as to reduce the complexity of CSI calculation for the UE (e.g., it is not necessary to calculate the CSI parameters based on the plurality of power parameters and/or spatial parameters, but only based on one power parameter and/or spatial parameter).

When a plurality of spatial parameters correspond to the same CQI parameter (first CQI parameter), one of the plurality of spatial parameters (for example, a spatial parameter other than the reference spatial parameter; for example, referred to as a first spatial parameter) determines precoding parameters (or CQI parameters) based on the reference spatial parameter (or a spatial parameter associated with the reference parameter). For example, the (wideband and/or subband) CQI parameters associated with the first spatial parameter are the same as those associated with the reference spatial parameter. Optionally, this method is suitable for the determination of broadband CQI parameters and/or for the determination of subband CQI parameters (for example, CQI parameters of each subband).

The advantage of this scheme is that the base station can obtain the precoding parameters corresponding to each spatial parameter based on the common CQI parameters of a plurality of spatial parameters reported by the UE, thus helping the base station use these parameters for more accurate scheduling.

Optionally, the mapping relationship (indicated by the base station) between the CSI parameters and (combinations of) power parameters and/or spatial parameters comprises that each of the (combinations of) power parameters and/or spatial parameters indicated by the base station among (combinations of) power parameters and/or spatial parameters corresponds to/is associated with a CQI parameter. Here, for a method of mapping/association between the plurality of power parameters and/or spatial parameters and the CQI parameter, please refer to the description of the predefined mapping relationship. Optionally, the base station may perform indication through at least one of RRC, MAC-CE or DCI.

Optionally, the mapping relationship (indicated by the base station) between the CSI parameters and (combinations of) power parameters and/or spatial parameters comprises that the (combinations of) power parameters and/or spatial parameters indicated by the base station among (combinations of) power parameters and/or spatial parameters correspond to/are associated with an CQI parameter. It can be understood that the base station here indicates a subset of the plurality of power parameters or the plurality of spatial parameters or combinations of the plurality of spatial parameters and power parameters related to the CSI parameters. Here, for a method of mapping/association between (the subset of) the plurality of power parameters and/or spatial parameters (indicated by the base station) and the CQI parameter, please refer to the description of the predefined mapping relationship. Optionally, the base station may perform indication through at least one of RRC, MAC-CE or DCI.

Using the above method, the base station can signal, based on the correlation level of parameters (e.g., the value of the offset between indexes of CQI parameters, the value of (measured) L1-RSRP corresponding to CQI parameters) L1-RSRP corresponding to CQI parameters), to separately report associated CSI parameters for a part of (combinations of) power parameters and/or spatial parameters, and report their associated (common or shared) CSI parameters in a single CSI report for another part of (combinations of) power parameters and/or spatial parameters, thus reducing the overhead of CSI report.

Optionally, the mapping relationship (reported by the UE/selected by the UE) between the CSI parameters and (combinations of) power parameters and/or spatial parameters comprises that each of (combinations of) power parameters and/or spatial parameters associated with a second indicator (or second information) among (combinations of) power parameters and/or spatial parameters corresponds to/is associated with a CQI parameter. Optionally, the CSI parameters comprise a second indicator (or second information). The UE reports the second indicator (or second information) to the base station. Optionally, the second indicator (or second information) is in the first CSI report. Here, for a method of mapping/association between the plurality of power parameters and/or spatial parameters and the CQI parameter, please refer to the description of the predefined mapping relationship. Optionally, among the plurality of power parameters and/or spatial parameters associated with the CSI parameters, for (combinations of) power parameters and/or spatial parameters not reported, the UE does not report CSI parameters corresponding to the (combinations of) power parameters and/or spatial parameters. Optionally, among the plurality of power parameters and/or spatial parameters associated with the CSI parameters, (combinations of) power parameters and/or spatial parameters not reported are associated with/correspond to/share one CQI parameter (for example, the first CQI parameter). For a method of mapping/association between the plurality of power parameters and/or spatial parameters and the CQI parameter, please refer to the description of the predefined mapping relationship.

Optionally, the mapping relationship between the CSI parameters and (combinations of) power parameters and/or spatial parameters (reported by the UE or associated with the second indicator or second information) comprises that (combinations of) power parameters and/or spatial parameters associated with the second indicator (or second information) among (combinations of) power parameters and/or spatial parameters correspond to/are associated with a CQI parameter. For example, the (combinations of) power parameters and/or spatial parameters associated with the second indicator share/correspond to the first CQI parameter. Optionally, the CSI parameters comprise a second indicator (or second information). The UE reports the second indicator (or second information) to the base station. Optionally, the second indicator (or second information) is in the first CSI report. Optionally, the second indicator (or second information) may be associated with the CRI. Here, for a method of mapping/association between the plurality of power parameters and/or spatial parameters and the CQI parameter, please refer to the description of the predefined mapping relationship. Optionally, among the plurality of power parameters and/or spatial parameters associated with the CSI parameters, for (combinations of) power parameters and/or spatial parameters not reported, the UE does not report CSI parameters corresponding to the (combinations of) power parameters and/or spatial parameters. Optionally, among the plurality of power parameters and/or spatial parameters associated with the CSI parameters, (combinations of) power parameters and/or spatial parameters not reported each correspond to/are each associated with a CQI parameter. For a method of mapping/association between the plurality of power parameters and/or spatial parameters and the CQI parameter, please refer to the description of the predefined mapping relationship.

Using the above method, the UE can, based on the correlation level of parameters (e.g., the value of the offset between indexes of CQI parameters, the value of (measured) L1-RSRP corresponding to CQI parameters) L1-RSRP corresponding to CQI parameters), separately report associated CSI parameters for a part of (combinations of) power parameters and/or spatial parameters, and report their associated CSI parameters in a single CSI report for another part of (combinations of) power parameters and/or spatial parameters, thus reducing the overhead of CSI report.

Optionally, the first CQI parameter (set) (e.g., described in the method above) comprises a wideband CQI and one or more subband CQI parameters. Here, those parameters included in the first CQI parameter can be determined by at least one of the following methods.

### Method I

The parameters included in the CQI parameter are predefined. For example, the parameter included in the first CQI parameter is a wideband CQI. For example, the mapping relationship between the CSI parameters and (combinations of) power parameters and/or spatial parameters comprises that (combinations of) power parameters and/or spatial parameters indicated by the base station among (combinations of) power parameters and/or spatial parameters correspond to/are associated with a wideband CQI. By this method, the UE can report the CSI parameters specified by a common protocol based on (combinations of) power parameters and/or spatial parameters, thereby reducing the overhead of CSI report.

### Method II

The parameters included in the CQI parameter are indicated by the base station. For example, the first CQI parameter indicated by the base station comprises wideband CQI parameters. For example, the mapping relationship between the CSI parameters and (combinations of) power parameters and/or spatial parameters comprises that (combinations of) power parameters and/or spatial parameters indicated by the base station among (combinations of) power parameters and/or spatial parameters correspond to/are associated with a CQI parameter (for example, the base station indicates that the CQI parameter is a wideband CQI). Optionally, the base station may perform indication through at least one of RRC, MAC-CE or DCI. By this method, the UE can report the common CSI parameters indicated by the base station based on (combinations of) power parameters and/or spatial parameters, thereby reducing the overhead of CSI report.

### Method III

The parameters included in the CQI parameter are reported/selected by the UE (and associated with a third indicator or third information). For example, the first CQI parameter associated with the third indicator (or the third information) comprises a wideband CQI. Optionally, the CSI parameters comprise the third indicator (or third information). The UE reports the third indicator (or third information) to the base station. Optionally, the third indicator (or third information) is in the first CSI report. Optionally, the third indicator (or third information) may be associated with the CRI. By this method, the UE can report the common CSI parameters selected by the UE based on (combinations of) power parameters and/or spatial parameters, thereby reducing the overhead of CSI report. Optionally, the calculation/determination of the above-mentioned CQI parameter is based on at least one of the following:
PMI associated with (combinations of) associated/corresponding power parameters and/or spatial parameters;
RI associated with (combinations of) associated/corresponding power parameters and/or spatial parameters;
reference signal resources associated with associated/corresponding power parameters and/or spatial parameters (for example, CRI indicated/associated reference signal resources).

Here, by taking LI parameters as the CSI parameters, a method for determining the mapping relationship between (combinations of) a plurality of power parameters and/or spatial parameters and the CSI parameters is explained.

Optionally, the mapping relationship between the CSI parameters and (combinations of) power parameters and/or spatial parameters is predefined or indicated by the base station or reported by the UE. Here, (combinations of) power parameters and/or spatial parameters may be all combinations of the power parameters and/or spatial parameters (described in the above method). (combinations of) power parameters and/or spatial parameters may also be a subset indicated by the base station, a subset reported by the UE or a predetermined subset of the combinations of the power parameters and/or spatial parameters (described in the above method).

Optionally, the (predefined) mapping relationship between the CSI parameters and (combinations of) power parameters and/or spatial parameters comprises that each of (combinations of) power parameters and/or spatial parameters corresponds to/is associated with a LI parameter. For example, each of (all) combinations of the plurality of power parameters and/or spatial parameters (associated with one or more reference signal resources) is associated with a LI parameter. For example, the power parameters and/or spatial parameters associated with a reference signal resource comprise/are associated with four parameter combinations {Spatial #1, Power #1}; {Spatial #1, Power #2}; {Spatial #2, Power #1}; {Spatial #2, Power #2}, and these four combinations correspond to LI parameters LI #1, LI #2, LI #3 and LI #4 respectively. LI #1 is determined/calculated based on {Spatial #1, Power #1}. LI #2 is determined/calculated based on {Spatial #1, Power #2}. LI #3 is determined/calculated based on {Spatial #2, Power #1}. LI #4 is determined/calculated based on {Spatial #2, Power #2}. For another example, the power parameters and/or spatial parameters associated with two reference signal resources comprise/are associated with four parameter combinations {Spatial #1, Power #1}; {Spatial #1, Power #2}; {Spatial #2, Power #1}; {Spatial #2, Power #2}, where a first reference signal resource comprises/is associated with two parameter combinations {Spatial #1, Power #1} and {Spatial #1, Power #2}. A second reference signal resource comprises/is associated with two parameter combinations {Spatial #2, Power #1} and {Spatial #2, Power #2}. These combinations (associated with the two reference signal resources) correspond to LI parameters LI #1, LI #2, LI #3 and LI #4 respectively. LI #1 is determined/calculated based on {Spatial #1, Power #1} of the first reference signal resource. LI #2 is determined/calculated based on {Spatial #1, Power #2} of the first reference signal resource. LI #3 is determined/calculated based on {Spatial #2, Power #1} of the second reference signal resource. LI #4 is determined/calculated based on {Spatial #2, Power #2} of the second reference signal resource. Optionally, the order of the (one or more) LI parameters is related to at least one of the following:
the order of the reference signal resources, for example, the order of the reference signal resources in a reference signal resource group (configuration information), and for another example, the order of reference signal resource (configuration) IDs;
the order of the (one or more) spatial parameters, for example, the order of the spatial parameters in corresponding configuration information/indication information, and for another example, the order of spatial parameter (associated configuration) IDs; and
the order of the (one or more) power parameters, for example, the order of the spatial parameters in corresponding configuration information/indication information, and for another example, the order of spatial parameter (associated configuration) IDs; and
the order of the (one or more) combinations of the spatial parameters and/or power parameters, for example, the order of the combinations of the spatial parameters and/or power parameters in corresponding configuration information/indication information, and for another example, the order of combination (associated configuration) IDs of spatial parameter and/or power parameter.

Optionally, the above methods for determining the order can be used simultaneously. For example, each method corresponds to a different priority. For example, the priority from high to low can be: the order of the reference signal resources>the order of the spatial parameters (if any)>the order of the power parameters. For example, the priority from high to low can be: the order of the reference signal resources>the order of the combinations of the spatial parameters and/or power parameters. For example, the order of the spatial parameters>the order of the power parameters. For example, the priority from high to low can be: the order of the reference signal resources>the order of the power parameters>the order of the spatial parameters. For example, the order of the power parameters>the order of the spatial parameters. For example, the priority from high to low can be: the order of the reference signal resources>the order of the power parameters.

Optionally, the (predefined) mapping relationship between the CSI parameters and (combinations of) power parameters and/or spatial parameters comprises that (combinations of) power parameters and/or spatial parameters correspond to/are associated with a LI parameter. For example, (all) combinations of the plurality of power parameters and/or spatial parameters (associated with one or more reference signal resources) are associated with a first LI parameter. For example, the power parameters and/or spatial parameters associated with a reference signal resource comprise/are associated with four parameter combinations {Spatial #1, Power #1}; {Spatial #1, Power #2}; {Spatial #2, Power #1}; {Spatial #2, Power #2}, and these four combinations are associated with/correspond to the LI parameter LI #1. Optionally, the first LI parameter is determined based on (specific) spatial parameters and/or power parameters.

Optionally, (if the first LI parameter is associated with a plurality of spatial parameters), the first LI parameter is determined based on (a specific one, one, part or all of) the spatial parameters. Optionally, the specific one, one, part or all of the spatial parameters are reference spatial parameters. Optionally, (if the first LI parameter is associated with a plurality of spatial parameters (associated with one or more reference signal resources)), the first LI parameter is determined based on a spatial parameter with the smallest number of ports or the largest number of ports among the plurality of spatial parameters (associated with one or more reference signal resources). Optionally, the spatial parameter with the smallest/largest number of ports among the plurality of spatial parameters may be a reference spatial parameter. Here, the number of ports can be equivalently replaced by at least one of the following: the first-dimension number, the second-dimension number, the first-dimension oversampling parameter and the second-dimension oversampling parameter. Optionally, the number of ports of the spatial parameter is 2*N₁*N₂, where N is the first-dimension number and N₂ is the second-dimension number. Optionally, the number of ports of the spatial parameter is N₁, where N₁ is the first-dimension number. Optionally, the number of ports of the spatial parameter is N₂, where N₂ is the second-dimension number. For example, if the first LI parameter is associated with Spatial #1 and Spatial #2, and the number of ports of Spatial #1 is smaller than that of Spatial #2, then the first LI parameter is determined based on Spatial #1. Optionally, if the first LI parameter is associated with a plurality of spatial parameters (associated with one or more reference signal resources) (if the numbers of ports associated with these spatial parameters are the same), the first LI parameter is determined based on a spatial parameter with the smallest or largest ID (for example, configured ID) among the plurality of spatial parameters (associated with one or more reference signal resources). Optionally, if the first LI parameter is associated with a plurality of spatial parameters (associated with one or more reference signal resources) (if the numbers of ports associated with these spatial parameters are the same), the first LI parameter is determined based on the positions of the plurality of spatial parameters in the signaling. For example, if the first LI parameter is associated with a plurality of spatial parameters (associated with one or more reference signal resources) (if the numbers of ports associated with these spatial parameters are the same), the first LI parameter is determined based on a first spatial parameter among the plurality of spatial parameters (for example, a first spatial parameter in the signaling carrying the plurality of spatial parameters).

Optionally, (if the first LI parameter is associated with a plurality of power parameters), the first LI parameter is determined based on (a specific one, one, part or all of) the power parameters. Optionally, the specific one, one, part or all of the power parameters are reference power parameters. Optionally, (if the first LI parameter is associated with a plurality of power parameters), the first LI parameter is determined based on a power parameter with the smallest power value or the largest power value among the plurality of power parameters. Optionally, (if the first LI parameter is associated with a plurality of power parameters (associated with one or more reference signal resources)), the first LI parameter is determined based on a power parameter with the smallest or largest ID (for example, configured ID) among the plurality of power parameters. Optionally, if the first LI parameter is associated with a plurality of power parameters (associated with one or more reference signal resources), the first LI parameter is determined based on the positions of the plurality of power parameters in the signaling. For example, if the first LI parameter is associated with a plurality of power parameters (associated with one or more reference signal resources), the first LI parameter is determined based on a first power parameter among the plurality of power parameters (for example, a first power parameter in the signaling carrying the plurality of power parameters).

Optionally, (if the first LI parameter is associated with a plurality of power parameters and/or spatial parameters), the first LI parameter is determined based on (one, part or all of (combinations of) specific or a plurality of power parameters and/or spatial parameters) power parameters and/or spatial parameters. Optionally, (combinations of) one, part or all of (combinations of) specific or a plurality of power parameters and/or spatial parameters are reference parameters. Optionally, (if the first LI parameter is associated with a plurality of power parameters and/or spatial parameters), the first LI parameter is determined based on (combinations of) a power parameter and/or spatial parameter with the smallest or largest ID (configured ID) among (combinations of) power parameters and/or spatial parameters. Optionally, (if the first LI parameter is associated with (combinations of) a plurality of power parameters and/or spatial parameters (associated with one or more reference signal resources), the first LI parameter is determined based on (combinations of) a power parameter with the smallest or largest ID (for example, configured ID) among the plurality of power parameters and/or the spatial parameters. Optionally, if the first LI parameter is associated with (combinations of) a plurality of power parameters and/or spatial parameters (associated with one or more reference signal resources), the first LI parameter is determined based on the positions of (combinations of) power parameters and/or spatial parameters in the signaling. For example, if the first LI parameter is associated with (combinations of) a plurality of power parameters and/or spatial parameters (associated with one or more reference signal resources), the first LI parameter is determined based on a first power parameter or spatial parameter among the plurality of power parameters (for example, (combinations of) a first power parameter or spatial parameter in the signaling carrying (combinations of) power parameters and/or spatial parameters).

The advantage of this scheme is that different spatial parameters and/or power parameters can share the same CSI parameters, which saves the overhead of CSI report. In addition, this scheme can determine a reference parameter (for calculating the CSI parameters) when there are a plurality of power parameters and/or spatial parameters, so as to reduce the complexity of CSI calculation for the UE (e.g., it is not necessary to calculate the CSI parameters based on the plurality of power parameters and/or spatial parameters, but only based on one power parameter and/or spatial parameter).

When a plurality of spatial parameters correspond to the same LI parameter (first LI parameter), one of the plurality of spatial parameters (for example, a spatial parameter other than the reference spatial parameter; for example, referred to as a first spatial parameter) determines precoding parameters (or LI parameters) based on the reference spatial parameter (or a spatial parameter associated with the reference parameter). For example, an LI associated with the first spatial parameter is equal to an LI associated with the reference spatial parameter.

The advantage of this scheme is that the base station can obtain the precoding parameters corresponding to each spatial parameter based on the common LI parameters of a plurality of spatial parameters reported by the UE, thus helping the base station use these parameters for more accurate scheduling.

Optionally, the mapping relationship (indicated by the base station) between the CSI parameters and (combinations of) power parameters and/or spatial parameters comprises that each of the (combinations of) power parameters and/or spatial parameters indicated by the base station among (combinations of) power parameters and/or spatial parameters corresponds to/is associated with a LI parameter. It can be understood that the base station here indicates a subset of the plurality of power parameters or the plurality of spatial parameters or combinations of the plurality of spatial parameters and power parameters related to the CSI parameters. Here, for a method of mapping/association between (the subset of) the plurality of power parameters and/or spatial parameters (indicated by the base station) and the LI parameter, please refer to the description of the predefined mapping relationship. Optionally, the base station may perform indication through at least one of RRC, MAC-CE or DCI.

Optionally, the mapping relationship (indicated by the base station) between the CSI parameters and (combinations of) power parameters and/or spatial parameters comprises that the (combinations of) power parameters and/or spatial parameters indicated by the base station among (combinations of) power parameters and/or spatial parameters correspond to/are associated with a LI parameter (for example, a first LI parameter). It can be understood that the base station here indicates a subset of the plurality of power parameters or the plurality of spatial parameters or combinations of the plurality of spatial parameters and power parameters related to the CSI parameters. Here, for a method of mapping/association between the plurality of power parameters and/or spatial parameters (indicated by the base station) and the LI parameter, please refer to the description of the predefined mapping relationship. Optionally, the base station may perform indication through at least one of RRC, MAC-CE or DCI.

Using the above method, the base station can signal, based on the correlation level of parameters (e.g., the value of the offset between indexes of LI parameters, the value of CQI or measured L1-RSRP corresponding to LI parameters) L1-RSRP corresponding to CQI parameters), to separately report associated CSI parameters for a part of (combinations of) power parameters and/or spatial parameters, and report their associated (common or shared) CSI parameters in a single CSI report for another part of (combinations of) power parameters and/or spatial parameters, thus reducing the overhead of CSI report.

Optionally, the mapping relationship (reported by the UE/selected by the UE) between the CSI parameters and (combinations of) power parameters and/or spatial parameters comprises that each of (combinations of) power parameters and/or spatial parameters associated with a second indicator (or second information) among (combinations of) power parameters and/or spatial parameters corresponds to/is associated with a LI parameter. Optionally, the CSI parameters comprise a second indicator (or second information). The UE reports the second indicator (or second information) to the base station. Optionally, the second indicator (or second information) is in the first CSI report. Here, for a method of mapping/association between the plurality of power parameters and/or spatial parameters and the LI parameter, please refer to the description of the predefined mapping relationship. Optionally, among the plurality of power parameters and/or spatial parameters associated with the CSI parameters, for (combinations of) power parameters and/or spatial parameters not reported, the UE does not report CSI parameters corresponding to the (combinations of) power parameters and/or spatial parameters. Optionally, among the plurality of power parameters and/or spatial parameters associated with the CSI parameters, (combinations of) power parameters and/or spatial parameters not reported are associated with/correspond to/share one LI parameter (for example, the first LI parameter). For a method of mapping/association between the plurality of power parameters and/or spatial parameters and the LI parameter, please refer to the description of the predefined mapping relationship.

Optionally, the mapping relationship between the CSI parameters and (combinations of) power parameters and/or spatial parameters (reported by the UE or associated with the second indicator or second information) comprises that (combinations of) power parameters and/or spatial parameters associated with the second indicator (or second information) among (combinations of) power parameters and/or spatial parameters correspond to/are associated with a LI parameter. For example, the (combinations of) power parameters and/or spatial parameters associated with the second indicator share/correspond to the first LI parameter. Optionally, the CSI parameters comprise a second indicator (or second information). The UE reports the second indicator (or second information) to the base station. Optionally, the second indicator (or second information) is in the first CSI report. Optionally, the second indicator (or second information) may be associated with the CRI. Here, for a method of mapping/association between the plurality of power parameters and/or spatial parameters and the LI parameter, please refer to the description of the predefined mapping relationship. Optionally, among the plurality of power parameters and/or spatial parameters associated with the CSI parameters, for (combinations of) power parameters and/or spatial parameters not reported, the UE does not report CSI parameters corresponding to the (combinations of) power parameters and/or spatial parameters. Optionally, among the plurality of power parameters and/or spatial parameters associated with the CSI parameters, (combinations of) power parameters and/or spatial parameters not reported each correspond to/are each associated with a LI parameter. For a method of mapping/association between the plurality of power parameters and/or spatial parameters and the LI parameter, please refer to the description of the predefined mapping relationship.

Using the above method, the UE can, based on the correlation level of parameters (e.g., the value of the offset between indexes of LI parameters, the value of CQI or measured L1-RSRP corresponding to LI parameters) L1-RSRP corresponding to CQI parameters), separately report associated CSI parameters for a part of (combinations of) power parameters and/or spatial parameters, and report their associated CSI parameters in a single CSI report for another part of (combinations of) power parameters and/or spatial parameters, thus reducing the overhead of CSI report.

Optionally, the calculation/determination of the above-mentioned LI parameter is based on at least one of the following:
CQI associated with (combinations of) associated/corresponding power parameters and/or spatial parameters;
PMI associated with (combinations of) associated/corresponding power parameters and/or spatial parameters;
RI associated with (combinations of) associated/corresponding power parameters and/or spatial parameters;
reference signal resources associated with associated/corresponding power parameters and/or spatial parameters (for example, CRI indicated/associated reference signal resources).

Optionally, the first CSI report comprises a first part and a second part. Optionally, the first part comprises at least one of the following: a second indicator; a third indicator; (one or more) RIs; (one or more) CRIs; (one or more) CQIs; and a zero-valued bit used to pad the first part to a fixed length. Optionally, the (one or more) CQIs may be (one or more) CQIs of (corresponding to) the first codeword.

Optionally, the second part comprises at least one of the following: (one or more) CQIs; (one or more) LIs; and (one or more) PMIs. Optionally, the (one or more) CQIs may be (one or more) CQIs of (corresponding to) the second codeword.

The advantage of splitting the CSI report into two parts is that the first part of CSI is limited to a fixed length, so as to avoid blind detection by the base station and reduce the detection complexity. Optionally, the size of the second part of the CSI may be determined based on the size of the first part. Here, the second indicator and/or the third indicator can be used to determine at least one of the following (in the second part of the CSI):
the number of the one or more RIs;
the number of the one or more PMIs (e.g., PMI sub-parameters);
the number of the one or more CQIs (e.g., CQI sub-parameters); and
the number of the one or more LIs.

Here, the third indicator can be used to select PMI sub-parameters in a set of PMIs.

Here, the third indicator can be used to select CQI sub-parameters in a set of CQIs. Optionally, the first part and the second part are encoded separately. The advantage of encoding the first part and the second part separately here is that the base station can decode the first part and the second part separately. The base station can determine the second part based on the first part. For example, based on the second indicator and/or the third indicator, which CSI parameters are present in the second part can be determined. Optionally, the first CSI report is in a PUCCH or PUSCH.

Optionally, when the PUCCH carry Type I CSI with wideband frequency granularity, CSI loads carried by PUCCH format 2, PUCCH format 3 or PUCCH format 4 are the same, regardless of at least one of RI (if reported), CRI (if reported), SSB resource indicator (SSBRI), L1-RSRP, L1-SINR, second indicator and third indicator (for example, regardless of the reporting situation or the reported value).

FIG. 5 illustrates a method 500 performed by a base station according to an embodiment of the disclosure. The method 500 comprises the following operations: in operation 501, a base station transmits information for configuring CSI report (for example, CSI report configuration information) to UE, wherein the information for configuring CSI report is associated with combinations of one or more spatial parameters and/or one or more power parameters; and in operation 502, the base station receives CSI parameters from the UE in a CSI report.

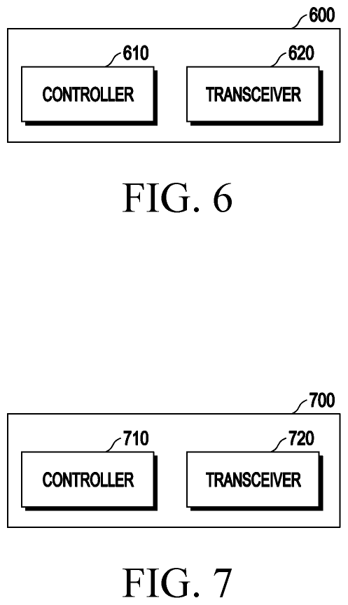

FIG. 6 illustrates a structure of a UE 600 according to an embodiment of the disclosure. Referring to FIG. 6, the UE 600 includes a controller 610 and a transceiver 620, wherein the controller 610 is configured to perform various methods performed by the UE disclosed above herein, and the transceiver 620 is configured to transmit and receive channels or signals.

FIG. 7 illustrates a structure of a base station 700 according to an embodiment of the disclosure. Referring to FIG. 7, the base station 700 includes a controller 710 and a transceiver 720, wherein the controller 710 is configured to perform various methods performed by the network device disclosed above herein, and the transceiver 720 is configured to transmit and receive channels or signals.

In the disclosure, the reference signal resource may be equivalently construed as a reference signal set. The reference signal resource may be equivalently construed as a reference signal resource. Codebook parameters can be equivalently understood as codebook configuration parameters.

In this application, the description of “combinations of spatial parameters and/or power parameters” can be replaced by the description of “one or more spatial parameters and/or one or more power parameters”.

Moreover, “at least one” described in the disclosure includes any and/or possible combinations of the listed items. Various embodiments described in the disclosure and various examples in the embodiments may be changed and combined in any proper way, and “/” used in the disclosure represents “and/or”.

Various illustrative logic blocks, modules, and circuits described in the disclosure may be implemented or executed by a general-purpose processor, a digital signal processor (DSP), an application specific integrated circuit (ASIC), a field programmable gate array (FPGA), or other programmable logic devices, discrete gate or transistor logics, discrete hardware components, or any combination designed to perform the functions described herein. The general-purpose processor may be a microprocessor. However, in an alternative, the processor may be any conventional processor, controller, microcontroller, or state machine. The processor may also be implemented as a combination of computing devices, such as a combination of a DSP and a microprocessor, multiple microprocessors, one or more microprocessors cooperating with the DSP core, or any other such configuration.

The steps of the methods or algorithms described in the disclosure may be embodied directly in hardware, in a software module executed by a processor, or in a combination of both. The software modules may reside in a RAM memory, a flash memory, a ROM memory, an erasable programmable read only memory (EPROM) memory, an electrically erasable programmable ROM (EEPROM) memory, registers, hard disks, removable disks, or any other form of storage medium known in the art. A storage medium is coupled to the processor, so that the processor can read and write information from/to the storage medium. In an alternative, the storage medium may be integrated into the processor. The processor and the storage medium may reside in the ASIC. The ASIC may reside in the user terminal. In the alternative, the processor and the storage medium may reside in the user terminal as discrete components.

In one or more designs, the functions may be implemented in hardware, software, firmware, or any combination thereof. If implemented in software, various functions may be stored on a computer-readable medium as or transmitted by one or more instructions or codes. The computer-readable medium includes both of a computer storage medium and a communication medium, and the latter includes any medium helping transfer of a computer program from one place to another place. The storage medium may be any available medium that can be accessed by a general-purpose or special-purpose computer.

In combination with the accompanying drawings, the descriptions set forth in the disclosure depict example configurations, methods, and apparatus, and do not represent all examples that can be implemented or within the scope of the claims. The term “example” used herein means “serving as an example, instance or illustration” rather than “preferred” or “superior to other examples”. The detailed descriptions included specific details intended to provide an understanding of the techniques described. However, these techniques can be practiced without these specific details. In some cases, well-known structures and devices are illustrated in the form of block diagrams to avoid obscuring the concepts of the described examples.

Although the specification includes the details of a plurality of specific implementations, these should not be construed as limitations to any disclosure or the claimed scope, but are descriptions of particular features of particular embodiments of particular disclosure. In the specification, some features described in the context of an individual embodiment may also be implemented in combination in a single embodiment. Rather, various features described in the context of a single embodiment may also be implemented separately in a plurality of embodiments or in any appropriate sub-combination. Moreover, although the features may be described in the context as functioning in some combinations and even initially claimed as such, in some cases, one or more features from the claimed combination may be deleted from the combination, and the claimed combination may be directed to a sub-combination or variations of the sub-combination.

It will be understood that the particular order or hierarchy of steps in the method of the disclosure is description of an example process. Based on design preference, it will be understood that the particular order or hierarchy of steps in the method may be rearranged to realize the functions and effects disclosed herein. The appended method claims present elements of various steps in an example order and are not meant to be limited to the presented particular order or hierarchy, unless particularly stated otherwise. Furthermore, although elements may be described or claimed in a singular form, plurals may also be contemplated unless limitations to singular forms are explicitly illustrated. Therefore, the disclosure is not limited to the illustrated examples, and any apparatus for performing the functionals described herein is included in various aspects of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, configuration information for a channel state information (CSI) report, the configuration information including a list of sub-configurations for the CSI report;
identifying, based on the list of sub-configurations, a mapping order for at least one of precoding matrix indicator (PMI) related to parameters or channel quality indicator (CQI) related parameters; and
transmitting, to the base station, the CSI report corresponding to one or more sub-configurations among the list of sub-configurations, based on the mapping order.

2. The method of claim 1,
wherein each sub-configuration in the list of sub-configurations includes an ID of a corresponding sub-configuration, and
wherein the mapping order is identified based on one or more IDs of one or more sub-configurations in the list of sub-configurations.

3. The method of claim 1, wherein each sub-configuration in the list of sub-configurations includes at least one of:
information indicating a number of antenna ports of channel state information-reference signal (CSI-RS) resources for the CSI report, or
information on a power offset for the CSI-RS resources.

4. The method of claim 1, wherein each sub-configuration in the list of sub-configurations includes a bitmap indicating whether each of antenna ports associated with CSI-RS resources for the CSI report is enabled or not.

5. The method of claim 1, wherein the list of sub-configurations includes a plurality of combinations of at least one of spatial parameters or power parameters associated with the CSI report.

6. A user equipment (UE) in a wireless communication system, the UE comprising:
a transceiver; and
a processor configured to:
receive, through the transceiver from a base station, configuration information for a channel state information (CSI) report, the configuration information including a list of sub-configurations for the CSI report,
identify, based on the list of sub-configurations, a mapping order for at least one of precoding matrix indicator (PMI) related to parameters or channel quality indicator (CQI) related parameters, and
transmit, to the base station through the transceiver, the CSI report corresponding to one or more sub-configurations among the list of sub-configurations, based on the mapping order.

7. The UE of claim 6,
wherein each sub-configuration in the list of sub-configurations includes an ID of a corresponding sub-configuration, and
wherein the mapping order is identified based on one or more IDs of one or more sub-configurations in the list of sub-configurations.

8. The UE of claim 6, wherein each sub-configuration in the list of sub-configurations includes at least one of:
information indicating a number of antenna ports of channel state information-reference signal (CSI-RS) resources for the CSI report, or
information on a power offset for the CSI-RS resources.

9. The UE of claim 6, wherein each sub-configuration in the list of sub-configurations includes a bitmap indicating whether each of antenna ports associated with CSI-RS resources for the CSI report is enabled or not.

10. The UE of claim 6, wherein the list of sub-configurations includes a plurality of combinations of at least one of spatial parameters or power parameters associated with the CSI report.

11. A method performed by a base station in a wireless communication system, the method comprising:
transmitting, to a user equipment (UE), configuration information for a channel state information (CSI) report, the configuration information including a list of sub-configurations for the CSI report;
identifying, based on the list of sub-configurations, a mapping order for at least one of precoding matrix indicator (PMI) related to parameters or channel quality indicator (CQI) related parameters; and
receiving, from the UE, the CSI report corresponding to one or more sub-configurations among the list of sub-configurations, based on the mapping order.

12. The method of claim 11,
wherein each sub-configuration in the list of sub-configurations includes an ID of a corresponding sub-configuration, and
wherein the mapping order is identified based on one or more IDs of one or more sub-configurations in the list of sub-configurations.

13. The method of claim 11, wherein each sub-configuration in the list of sub-configurations includes at least one of:
information indicating a number of antenna ports of channel state information-reference signal (CSI-RS) resources for the CSI report, or
information on a power offset for the CSI-RS resources.

14. The method of claim 11, wherein each sub-configuration in the list of sub-configurations includes a bitmap indicating whether each of antenna ports associated with CSI-RS resources for the CSI report is enabled or not.

15. The method of claim 11, wherein the list of sub-configurations includes a plurality of combinations of at least one of spatial parameters or power parameters associated with the CSI report.

16. A base station in a wireless communication system, the base station comprising:
a transceiver; and
a processor configured to:
transmit, to a user equipment (UE) through the transceiver, configuration information for a channel state information (CSI) report, the configuration information including a list of sub-configurations for the CSI report,
identify, based on the list of sub-configurations, a mapping order for at least one of precoding matrix indicator (PMI) related to parameters or channel quality indicator (CQI) related parameters, and
receive, through the transceiver from the UE, the CSI report corresponding to one or more sub-configurations among the list of sub-configurations, based on the mapping order.

17. The base station of claim 16,
wherein each sub-configuration in the list of sub-configurations includes an ID of a corresponding sub-configuration, and
wherein the mapping order is identified based on one or more IDs of one or more sub-configurations in the list of sub-configurations.

18. The base station of claim 16, wherein each sub-configuration in the list of sub-configurations includes at least one of:
information indicating a number of antenna ports of channel state information-reference signal (CSI-RS) resources for the CSI report, or
information on a power offset for the CSI-RS resources.

19. The base station of claim 16, wherein each sub-configuration in the list of sub-configurations includes a bitmap indicating whether each of antenna ports associated with CSI-RS resources for the CSI report is enabled or not.

20. The base station of claim 16, wherein the list of sub-configurations includes a plurality of combinations of at least one of spatial parameters or power parameters associated with the CSI report.
